(19) United States
(12) Patent Application Publication
(10) Pub. No.: US 2026/0100771 A1
(43) Pub. Date: Apr. 9, 2026

(54) LAYER 1 CROSS LINK INTERFERENCE REPORTING

(71) Applicant: QUALCOMM Incorporated, San Diego, CA (US)

(72) Inventors: Qian ZHANG, Basking Ridge, NJ (US); Yan ZHOU, San Diego, CA (US)

(21) Appl. No.: 19/345,411

(22) Filed: Sep. 30, 2025

Related U.S. Application Data
(60) Provisional application No. 63/703,677, filed on Oct. 4, 2024.

(51) Int. Cl. H04B 17/318; H04L 5/00; H04L 5/14; H04W 24/10

(52) U.S. Cl. CPC H04B 17/328; H04L 5/0044; H04L 5/14; H04W 24/10

(57) ABSTRACT

Various aspects of the present disclosure generally relate to wireless communication. In some aspects, a user equipment (UE) may perform one or more cross link interference (CLI) received signal strength indicator (RSSI) measurements in one or more CLI-RSSI measurement resources in one or more subband full duplex (SBFD) symbols. The UE may transmit a CLI report based at least in part on the one or more CLI-RSSI measurements, where the CLI report indicates one or more measurement values associated with N (N≥1) CLI-RSSI measurement resources of the one or more CLI-RSSI measurement resources, the one or more measurement values including at least one of a single wideband measurement value or one or more per-downlink-subband measurement values. Numerous other aspects are described.

### CROSS-REFERENCE TO RELATED APPLICATION

This Patent Application claims priority to U.S. Provisional Ser. No. 63/703,677, filed on Oct. 4, 2024, entitled “LAYER 1 CROSS LINK INTERFERENCE REPORTING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with Layer 1 cross link interference reporting.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include performing one or more cross link interference (CLI) received signal strength indicator (RSSI) measurements in one or more CLI-RSSI measurement resources in one or more subband full duplex (SBFD) symbols. The method may include transmitting a CLI report based at least in part on the one or more CLI-RSSI measurements, where the CLI report indicates one or more measurement values associated with a first number (N (N≥1)) of CLI-RSSI measurement resources of the one or more CLI-RSSI measurement resources, the one or more measurement values including at least one of, a single wideband measurement value indicating an average CLI-RSSI associated with a plurality of downlink subbands of a CLI-RSSI measurement resource of the first number (N) of CLI-RSSI measurement resources, or one or more per-downlink-subband measurement values indicating one or more CLI-RSSIs associated with one or more downlink subbands of the plurality of downlink subbands of the CLI-RSSI measurement resource of the N CLI-RSSI measurement resources.

Some aspects described herein relate to a UE for wireless communication. The user equipment may include one or more memories and one or more processors coupled to the one or more memories. The one or more processors may be configured to perform one or more CLI-RSSI measurements in one or more CLI-RSSI measurement resources in one or more SBFD symbols. The one or more processors may be configured to transmit a CLI report based at least in part on the one or more CLI-RSSI measurements, where the CLI report indicates one or more measurement values associated with a first number (N (N≥1)) of CLI-RSSI measurement resources of the one or more CLI-RSSI measurement resources, the one or more measurement values including at least one of, a single wideband measurement value indicating an average CLI-RSSI associated with a plurality of downlink subbands of a CLI-RSSI measurement resource of the first number (N) of CLI-RSSI measurement resources, or one or more per-downlink-subband measurement values indicating one or more CLI-RSSIs associated with one or more downlink subbands of the plurality of downlink subbands of the CLI-RSSI measurement resource of the first number (N) of CLI-RSSI measurement resources.

Some aspects described herein relate to a non-transitory computer-readable medium that stores a set of instructions for wireless communication by a UE. The set of instructions, when executed by one or more processors of the UE, may cause the UE to perform one or more CLI-RSSI measurements in one or more CLI-RSSI measurement resources in one or more SBFD symbols. The set of instructions, when executed by one or more processors of the UE, may cause the UE to transmit a CLI report based at least in part on the one or more CLI-RSSI measurements, where the CLI report indicates one or more measurement values associated with a first number (N (N≥1)) of CLI-RSSI measurement resources of the one or more CLI-RSSI measurement resources, the one or more measurement values including at least one of, a single wideband measurement value indicating an average CLI-RSSI associated with a plurality of downlink subbands of a CLI-RSSI measurement resource of the first number (N) of CLI-RSSI measurement resources, or one or more per-downlink-subband measurement values indicating one or more CLI-RSSIs associated with one or more downlink subbands of the plurality of downlink subbands of the CLI-RSSI measurement resource of the first number (N) of CLI-RSSI measurement resources.

Some aspects described herein relate to an apparatus for wireless communication. The apparatus may include means for performing one or more CLI-RSSI measurements in one or more CLI-RSSI measurement resources in one or more SBFD symbols. The apparatus may include means for transmitting a CLI report based at least in part on the one or more CLI-RSSI measurements, where the CLI report indicates one or more measurement values associated with a first number (N (N≥1)) of CLI-RSSI measurement resources of the one or more CLI-RSSI measurement resources, the one or more measurement values including at least one of, a single wideband measurement value indicating an average CLI-RSSI associated with a plurality of downlink subbands of a CLI-RSSI measurement resource of the first number (N) of CLI-RSSI measurement resources, or one or more per-downlink-subband measurement values indicating one or more CLI-RSSIs associated with one or more downlink subbands of the plurality of downlink subbands of the CLI-RSSI measurement resource of the first number (N) of CLI-RSSI measurement resources.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples of full-duplex communication in a wireless network, in accordance with the present disclosure.

FIG. 4 is a diagram illustrating examples relating to cross link interference (CLI), in accordance with the present disclosure.

FIG. 5 is a diagram illustrating an example of CLI received signal strength indicator (RSSI) and CLI reference signal received power (RSRP) resources in subbands of subband full-duplex (SBFD) symbols, in accordance with the present disclosure.

FIGS. 6A-6E are diagrams illustrating examples associated with layer 1 CLI reporting, in accordance with the present disclosure.

FIG. 7 is a diagram illustrating an example process performed, for example, at a user equipment (UE) or an apparatus of a UE, in accordance with the present disclosure.

FIG. 8 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless communication system may support full-duplex (FD) communication. FD communication enables contemporaneous uplink and downlink communication using the same resources. For example, when FD communication is supported, a network node may transmit a downlink transmission to a first UE in a first set of resources (e.g., a set of time and frequency resources) and may receive an uplink communication from a second UE in a second set of resources, with the first set of resources and the second set of resources at least partially overlapping in the frequency domain or the time domain.

One type of FD communication is subband FD (SBFD) communication, which may also be referred to as “subband frequency division duplex (SBFDD)” or “flexible duplex.” In one example of SBFD communication, a first UE may transmit an uplink communication to a network node, and a second UE may receive a downlink communication from the network node at the same time, but on different frequency resources. The different frequency resources may be subbands of a frequency band, such as a time division duplexing band (e.g., different frequency bands in an active downlink bandwidth part). In this case, the frequency resources used for downlink communication may be separated from the frequency resources used for uplink communication by a guard band in the frequency domain. One advantage of SBFD is an increase in uplink duty cycle, which serves to reduce latency (e.g., an uplink signal can be transmitted in an uplink subband in a downlink-only slot or a flexible slot) and can improve uplink coverage. Other advantages of SBFD include improvement to system capacity/resource utilization/spectrum efficiency and enablement of flexible and dynamic uplink/downlink resource adaption according to uplink/downlink traffic at a given time.

However, cross-link interference (CLI) may be problematic in an FD communication scenario. In general, CLI refers to interference resulting from communications in different transmission directions (e.g., downlink versus uplink) in the same set of resources in the time domain (e.g., the same transmission time interval (TTI)). Therefore, a UE capable of participating in FD communication may need measure CLI for reporting to a network node. In an SBFD scenario, one option for a resource in which the UE is can perform a measurement based at least in part on which CLI (e.g., inter-UE CLI) can be derived may include a CLI received signal strength indicator (RSSI) measurement resource in an SBFD symbol in one or more downlink subbands of an active downlink bandwidth part.

In some systems, Layer 1 (L1)-based measurement and reporting may be used in association with reporting UE-to-UE CLI, with the L1-based UE-to-UE CLI measurement and reporting being based on a conventional channel state information (CSI) framework. L1-based measurement and reporting may be desirable in order to, for example, reduce CLI measurement and reporting latency, enable measurement and reporting of short term CLI, and to facilitate transmission scheduling by a network node. With respect to CLI measurement, configuration of a periodic, semi-persistent, or aperiodic measurement resource (e.g., a sounding reference signal (SRS) reference signal receive power (RSRP) measurement resource or CLI-RSSI measurement resource) is needed, in addition to configuration or determination of a ‘typeD’ quasi co-location (QCL) assumption for the measurement resource. With respect to reporting of the CLI measurement, aperiodic reporting, periodic reporting, or semi-persistent reporting may be configured to enable reporting of one or more report quantities (e.g., L1-SRS-RSRPs, L1-CLI-RSSIs, or measurement resource indices). Further, generation of uplink control information (UCI) bits, priority rules for reporting multiple CLI, and a CLI measurement accuracy requirement can be defined.

For L1-based UE-to-UE CLI measurement and reporting, the following types of frequency resource allocations of a CLI-RSSI measurement resource may be supported: (1) one CLI-RSSI measurement resource configured within one downlink subband of an active downlink bandwidth part (referred to measurement resource type #1) and (2) one CLI-RSSI measurement resource configured across two downlink subbands of an active downlink bandwidth part (referred to measurement resource type #2). If a UE is configured to perform a measurement in a type #1 CLI-RSSI measurement resource in SBFD symbols, then the UE can measure CLI in the downlink subband and report the measured CLI in the (single) downlink subband. However, a manner in which a UE determines a type #2 CLI-RSSI measurement resource, performs measurement(s) in the type #2 CLI-RSSI measurement resource, and reports CLI-RSSI measurement value(s) associated with type #2 CLI-RSSI measurement resource needs to be defined.

Various aspects relate generally to L1-based CLI reporting. Some aspects more specifically relate to determination of CLI-RSSI measurement resources in SBFD symbols (e.g., type #2 CLI-RSSI measurement resources), performance of CLI-RSSI measurements in the CLI-RSSI measurement resources in the SBFD symbols, and transmission of a CLI report based at least in part on the CLI-RSSI measurements. In some aspects, the CLI report indicates measurement values associated with N (N≥1) CLI-RSSI measurement resources.

Particular aspects of the subject matter described in this disclosure can be implemented to realize one or more of the following potential advantages. In some examples, by enabling L1-based CLI-RSSI measurement and reporting, the described techniques can be used to support CLI-RSSI measurement and reporting in an SBFD scenario, which enables CLI mitigation that can be used to reduce CLI with respect to SBFD communication, therefore improving wireless communication reliability. Further, the techniques and apparatuses associated with L1-based CLI-RSSI measurement and reporting described herein may reduce CLI measurement and reporting latency (e.g., as compared to layer 3 (L3)-based CLI measurement and reporting), enable measurement and reporting of short term CLI, and to facilitate transmission scheduling by a network node.

In some aspects, the measurement values included in the CLI report may include a wideband measurement value indicating an average CLI-RSSI associated with downlink subbands of each of the N CLI-RSSI measurement resources. As a particular example, in some aspects, a UE may perform a measurement in a CLI-RSSI measurement resource in SBFD symbols using a CLI-RSSI measurement resource of measurement resource type #2, and the UE may report a “wideband” CLI-RSSI measurement value that represents an average CLI-RSSI across two downlink subbands of the CLI-RSSI measurement resource. Such an aspect may be desirable in a scenario in which reduction (e.g., minimization) of overhead associated with L1-based CLI reporting is desired.

Additionally, or alternatively, the measurement values included in the CLI report may include per-downlink-subband measurement values indicating CLI-RSSIs associated with each of the downlink subbands of each of the N CLI-RSSI measurement resources. For example, in some aspects, the UE may perform a measurement in a CLI-RSSI measurement resource in SBFD symbols using a CLI-RSSI measurement resource of measurement resource type #2, and the UE may report per-downlink-subband CLI-RSSI measurement values—one measurement value for each downlink subband of the CLI-RSSI measurement resource. Such an aspect may be desirable in a scenario in which accurate per-downlink-subband CLI reporting is desirable, such as a scenario in which CLI-RSSIs differ significantly between downlink subbands of an SBFD symbol.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

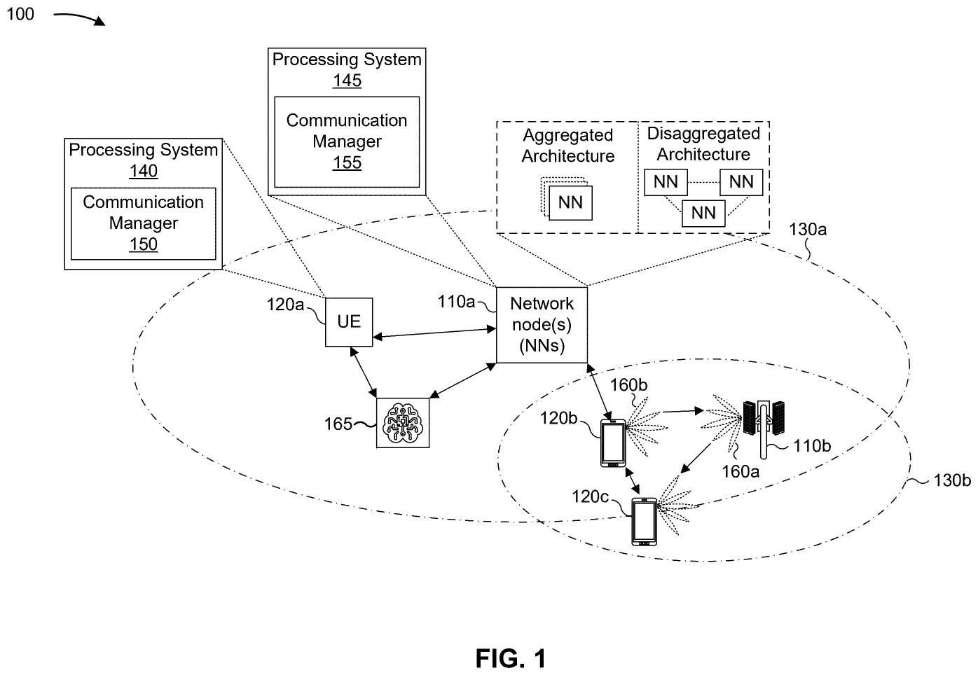

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

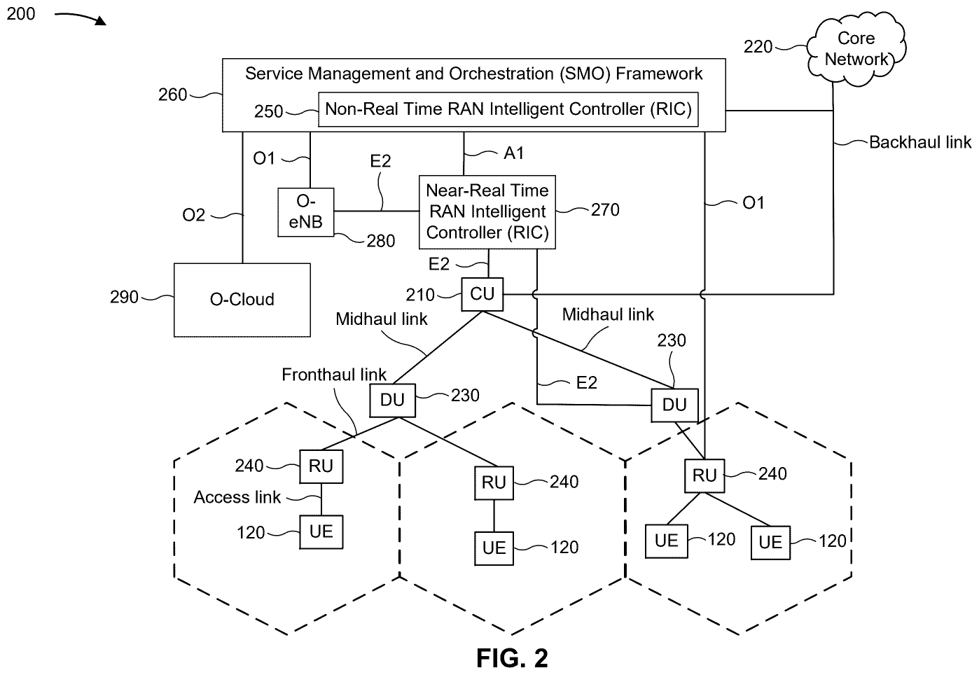

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 and/or UEs 120 may generally increase the capacity of the network and the radio access link. In some examples, full-duplex operation may involve frequency division duplexing (FDD), in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

In some aspects, the UE 120 may include a communication manager 150. As described in more detail elsewhere herein, the communication manager 150 may perform one or CLI-RSSI measurements in one or more CLI-RSSI measurement resources in one or more SBFD symbols; and transmit a CLI report based at least in part on the one or more CLI-RSSI measurements, where the CLI report indicates one or more measurement values associated with N (N≥1) CLI-RSSI measurement resources of the one or more CLI-RSSI measurement resources, the one or more measurement values including at least one of: a single wideband measurement value indicating an average CLI-RSSI associated with a plurality of downlink subbands of a CLI-RSSI measurement resource of the N CLI-RSSI measurement resources, or one or more per-downlink-subband measurement values indicating one or more CLI-RSSIs associated with one or more downlink subbands of the plurality of downlink subbands of the CLI-RSSI measurement resource of the N CLI-RSSI measurement resources. Additionally, or alternatively, the communication manager 150 may perform one or more other operations described herein.

In some aspects, the network node 110 may include a communication manager 155. As described in more detail elsewhere herein, the communication manager 155 may receive a CLI report based at least in part on one or more CLI-RSSI measurements performed by a UE 120, where the CLI report indicates one or more measurement values associated with N (N≥1) CLI-RSSI measurement resources of the one or more CLI-RSSI measurement resources, the one or more measurement values including at least one of: a single wideband measurement value indicating an average CLI-RSSI associated with a plurality of downlink subbands of a CLI-RSSI measurement resource of the N CLI-RSSI measurement resources, or one or more per-downlink-subband measurement values indicating one or more CLI-RSSIs associated with one or more downlink subbands of the plurality of downlink subbands of the CLI-RSSI measurement resource of the N CLI-RSSI measurement resources. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

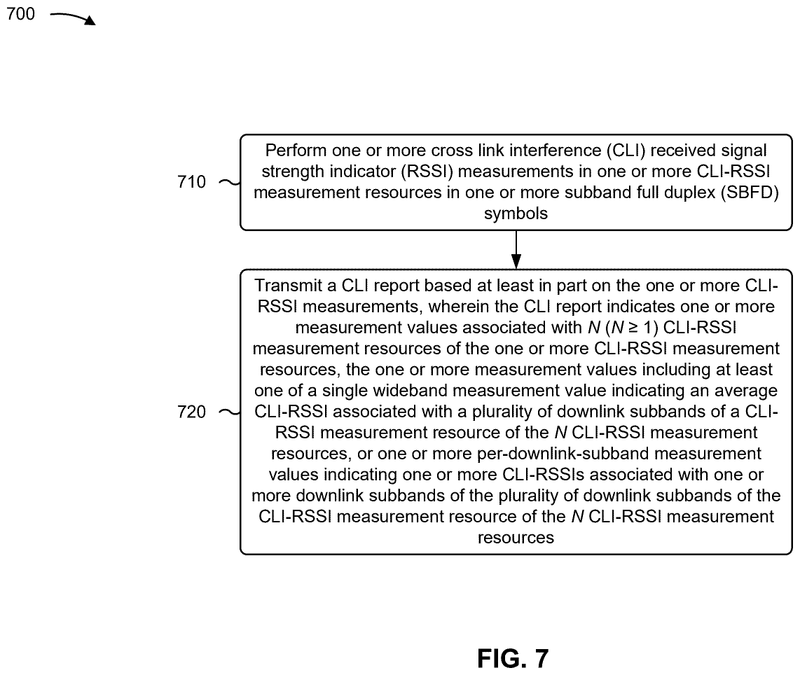

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with L1 CLI reporting, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, or other processes as described herein. In some examples, executing instructions may include running the instructions, converting the instructions, compiling the instructions, and/or interpreting the instructions, among other examples.

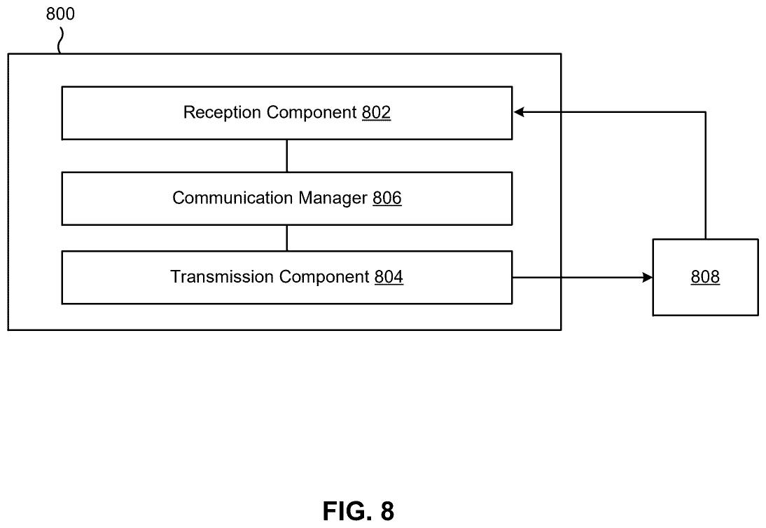

In some aspects, the UE 120 includes means for performing one or more CLI-RSSI measurements in one or more CLI-RSSI measurement resources in one or more SBFD symbols; and/or means for transmitting a CLI report based at least in part on the one or more CLI-RSSI measurements, where the CLI report indicates one or more measurement values associated with N (N≥1) CLI-RSSI measurement resources of the one or more CLI-RSSI measurement resources, the one or more measurement values including at least one of: a single wideband measurement value indicating an average CLI-RSSI associated with a plurality of downlink subbands of a CLI-RSSI measurement resource of the N CLI-RSSI measurement resources, or one or more per-downlink-subband measurement values indicating one or more CLI-RSSIs associated with one or more downlink subbands of the plurality of downlink subbands of the CLI-RSSI measurement resource of the N CLI-RSSI measurement resources. The means for the UE 120 to perform operations described herein may include, for example, one or more of communication manager 150, processing system 140, a radio, one or more RF chains, one or more transceivers, one or more antennas, one or more modems, a reception component (e.g., reception component 802 depicted and described in connection with FIG. 8) and/or a transmission component (e.g., transmission component 804 depicted and described in connection with FIG. 8), among other examples.

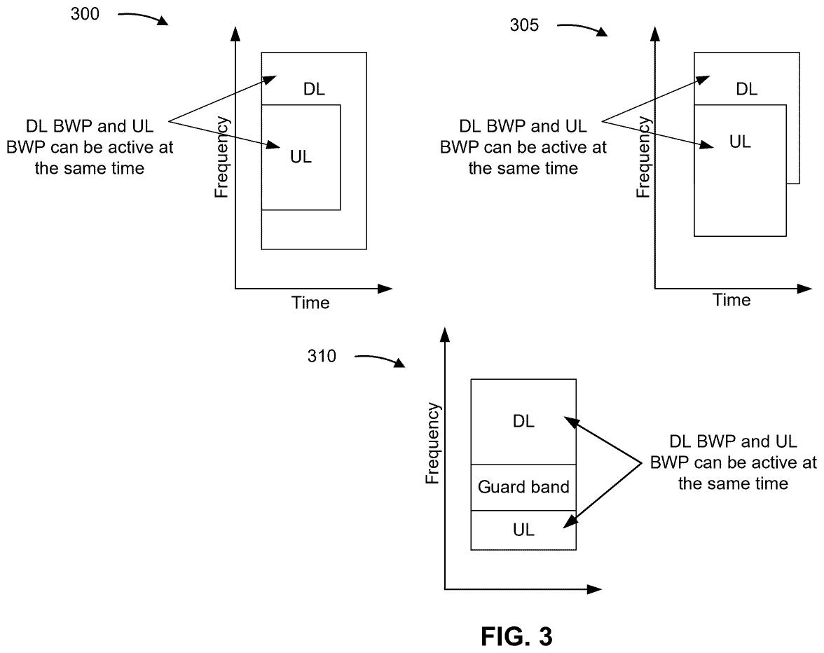

FIG. 3 is a diagram illustrating examples 300, 305, and 310 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 3, examples 300 and 305 show examples of in-band full-duplex (IBFD) communication. In IBFD, a UE may transmit an uplink communication to a base station and receive a downlink communication from the base station on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

As further shown in FIG. 3, example 310 shows an example of SBFD communication, which may also be referred to as “sub-band frequency division duplex (SBFDD)” or “flexible duplex.” In SBFD, a UE may transmit an uplink communication to a base station and receive a downlink communication from the base station at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

In some aspects, the techniques and apparatuses described herein associated with L1-based CLI reporting can be applied with respect to FD communication as described with respect to FIG. 3.

As indicated above, FIG. 3 is provided as an example. Other examples may differ from what is described with respect to FIG. 3.

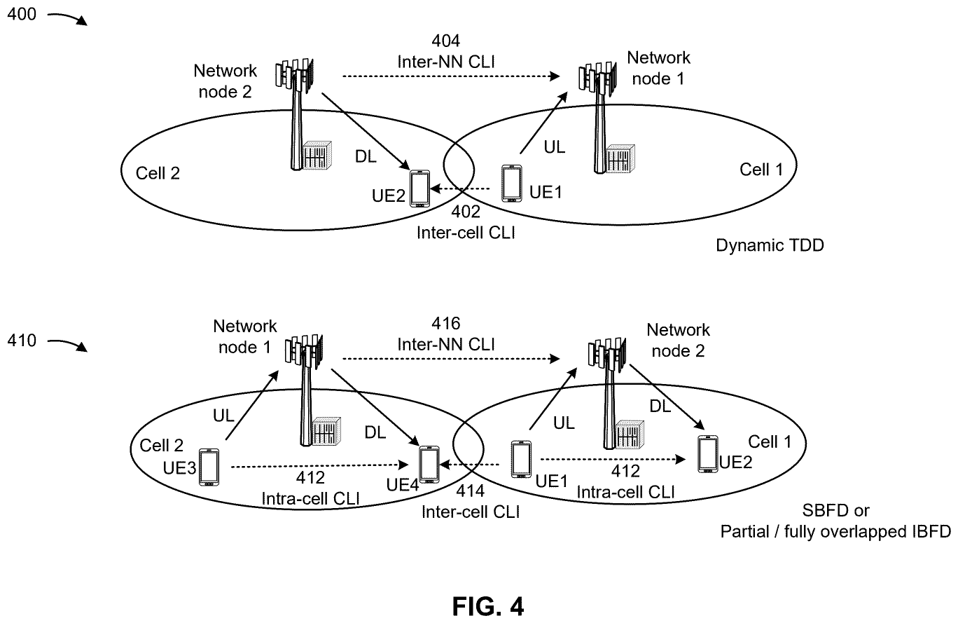

FIG. 4 is a diagram illustrating examples 400 and 410 relating to CLI, in accordance with the present disclosure.

Example 400 shows an example of dynamic TDD communication. As shown in example 400, when dynamic TDD is implemented, neighboring cells (cell 1 and cell 2) may use different TDD configurations to communicate with UEs, which may result in an uplink communication between a first UE (UE1) and a first network node (network node 1) in a same transmission time interval (TTI) as a downlink communication between a second network node (network node 2) and a second UE (UE2). These communications in different transmission directions (e.g., downlink versus uplink) in the same TTI may interfere with one another, which may be referred to as CLI.

Interference with reception of a downlink communication by one UE caused by transmission of an uplink communication by another UE may be referred to as UE-to-UE CLI or inter-UE CLI. For example, as shown at reference 402, in the dynamic TDD scenario, transmission of the uplink communication in a symbol or a slot by UE1 in cell 1 may interfere with reception of the downlink communication in the symbol or the slot by UE2 in cell 2. Such interference may be referred to as inter-cell UE-to-UE CLI or inter-cell inter-UE CLI.

Interference with reception of an uplink communication by a network node caused by transmission of a downlink communication by another network node may be referred to as inter-network-node (inter-NN) CLI (e.g., inter-gNB CLI). For example, as shown at reference 404, in the dynamic TDD scenario, transmission of the downlink communication in a symbol or a slot by network node 2 in cell 2 may interfere with reception of the uplink communication in the symbol or the slot by network node 1 in cell 1. Such interference may be referred to as inter-cell inter-NN CLI.

Example 410 shows an example of FD communication, such as SBFD, fully overlapping IBFD, or partial overlapping IBFD. As shown at reference 412, in an FD scenario, transmission of an uplink communication in an SBFD or IBFD slot or symbol by one UE in a cell may interfere with reception of a downlink communication in the SBFD or IBFD slot or symbol by another UE in the cell. For example, transmission of an uplink communication in an SBFD or IBFD slot or symbol by UE1 in cell 1 may interfere with reception of a downlink communication in the SBFD or IBFD slot or symbol by UE2 in cell 1. As another example, transmission of an uplink communication in an SBFD or IBFD slot or symbol by UE3 in cell 2 may interfere with reception of a downlink communication in the SBFD or IBFD slot or symbol by UE4 in cell 2. Such interference may be referred to as intra-cell UE-to-UE CLI or intra-cell inter-UE CLI. In an SBFD scenario, transmission of an uplink communication on an uplink sub-band (SB) in an SBFD symbol or slot by one UE (for example, UE1) in a cell (for example, cell 1) may interfere with reception of a downlink communication on a downlink SB in the SBFD symbol or slot by another UE (for example, UE2) in the cell. Such interference may be referred to as inter-SB intra-cell UE-to-UE CLI or inter-SB intra-cell inter-UE CLI.

As shown at reference 414, in an FD scenario, transmission of an uplink communication in an SBFD or an IBFD symbol or slot by UE1 in cell 1 may interfere with reception of a downlink communication in the SBFD of IBFD symbol or slot by UE4 in cell 2. Such interference may be referred to as inter-cell inter-UE CLI. In an SBFD scenario, transmission of an uplink communication on an uplink SB in an SBFD symbol or slot by UE1 in cell 1 may interfere with reception of a downlink communication on a downlink SB in the SBFD symbol or slot by UE4 in cell 2. Such interference may be referred to as inter-SB inter-cell inter-UE CLI.

As noted above, interference with reception of an uplink communication by a network node caused by transmission of a downlink communication by another network node may be referred to as inter-NN CLI. For example, as shown at reference 416, in an FD scenario, transmission of a downlink communication in a symbol or a slot by network node 2 in cell 2 may interfere with reception of the uplink communication in the symbol or the slot by network node 1 in cell 1. In an SBFD scenario, transmission of a downlink communication on a downlink SB in an SBFD symbol or slot by network node 1 in cell 2 may interfere with reception of an uplink communication on an uplink SB in the SBFD symbol or slot by network node 1 in cell 12. Such interference may be referred to as inter-SB inter-cell CLI or inter-SB inter-cell inter-NN CLI.

In some aspects, the techniques and apparatuses described herein associated with L1-based CLI reporting can be applied with respect to CLI as described with respect to FIG. 4.

As indicated above, FIG. 4 is provided as an example. Other examples may differ from what is described with regard to FIG. 4.

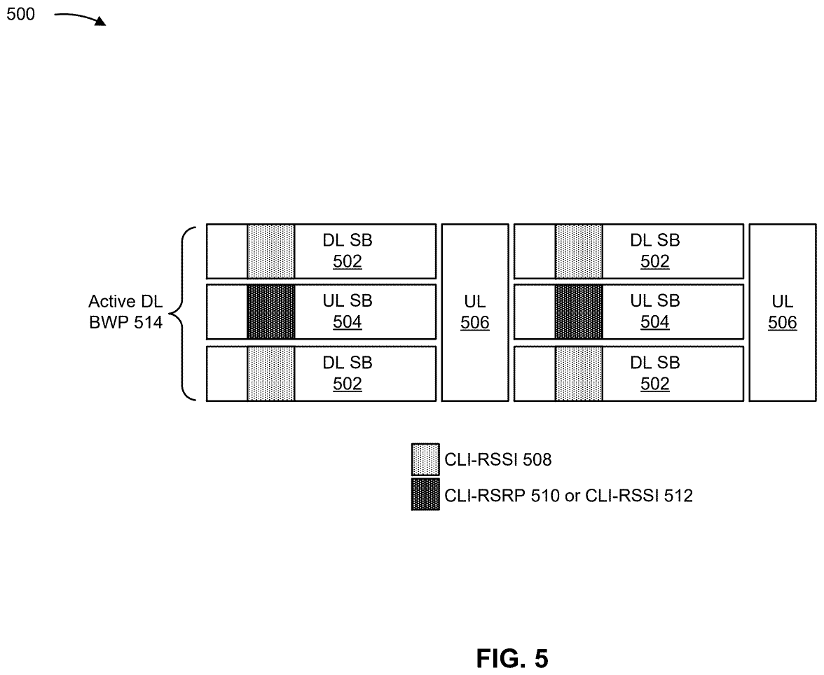

FIG. 5 is a diagram illustrating an example 500 of CLI-RSSI and CLI-RSRP resources in subbands of SBFD symbols, in accordance with the present disclosure. In example 500, the active downlink bandwidth part 514 comprises one or more SBFD symbols - represented by portions of the active downlink bandwidth part 514 that comprises the downlink subbands 502 and the uplink subband 504—and one or more non-SBFD symbols—represented by a portion of the active downlink bandwidth part 514 that comprises the uplink band 506.

As described above, a UE capable of participating in SBFD communication may need to perform measurements based at least in part on which CLI can be derived. In some aspects, the resource in which the UE is to perform such a measurement may include (1) a CLI-RSSI resource 508 in an SBFD symbol in a downlink subband 502 of the active downlink bandwidth part 514, (2) a CLI-RSRP resource 510 of an aggressor UE in an SBFD symbol in an uplink subband 504 of the active downlink bandwidth part 514, (3) a CLI-RSSI resource 512 in an SBFD symbol in an uplink subband 504 of the active downlink bandwidth part 514, or (4) a CLI-RSSI resource in an SBFD symbol in a guard band of the active downlink bandwidth part 514 (e.g., a region between a downlink subband 502 and the uplink subband 504).

One technique for UE-to-UE CLI-RSSI measurement and reporting across downlink subbands 502 is to perform separate CLI-RSSI resource measurement and reporting for each downlink subband 502 of the active downlink bandwidth part 514. This technique allows flexible configuration of measurement reporting in one downlink subband 502 or two downlink subbands 502. Another technique for UE-to-UE CLI-RSSI measurement and reporting across downlink subbands 502 is to perform CLI-RSSI resource measurement and reporting in only one downlink subband 502 of the active downlink bandwidth part 514. This technique reduces consumption in that it does not consume multiple CLI-RSSI measurement resources from a UE capability perspective. Another technique for UE-to-UE CLI-RSSI measurement and reporting across downlink subbands 502 is to perform CLI-RSSI resource measurement and reporting based on a non-contiguous CLI-RSSI resource across multiple downlink subbands 502 of the active downlink bandwidth part 514. This technique is similar to non-contiguous CSI-RS resource allocation, and a single CLI report based on non-contiguous a CLI-RSSI resource may be used. Furthermore, this technique reduces consumption in that it does not consume multiple CLI-RSSI measurement resources from a UE capability perspective.

In some aspects, the techniques and apparatuses described herein associated with L1-based CLI reporting can be applied with respect to CLI-RSSI and CLI-RSRP resources in subbands of SBFD symbols as described with respect to FIG. 5.

As indicated above, FIG. 5 is provided as an example. Other examples may differ from what is described with regard to FIG. 5.

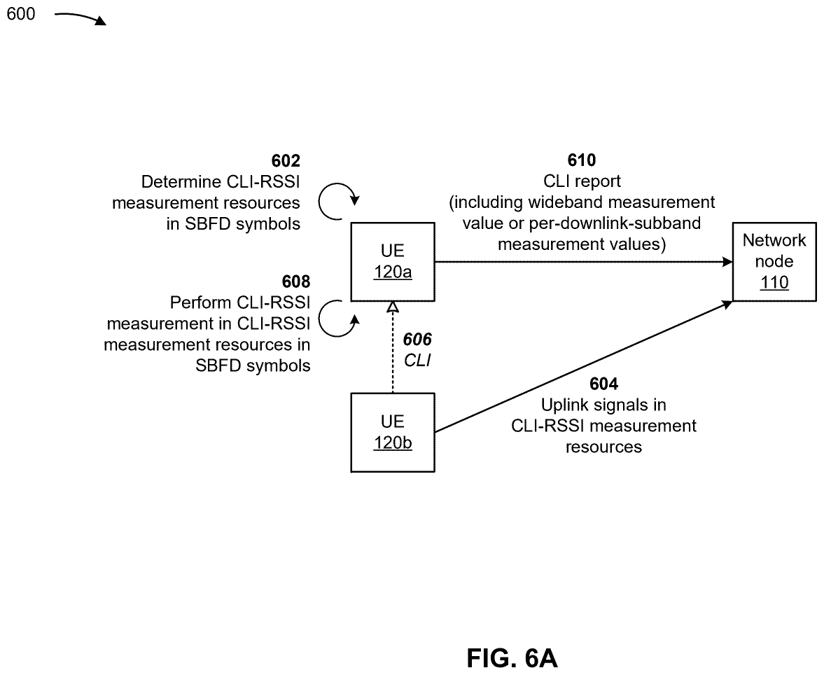

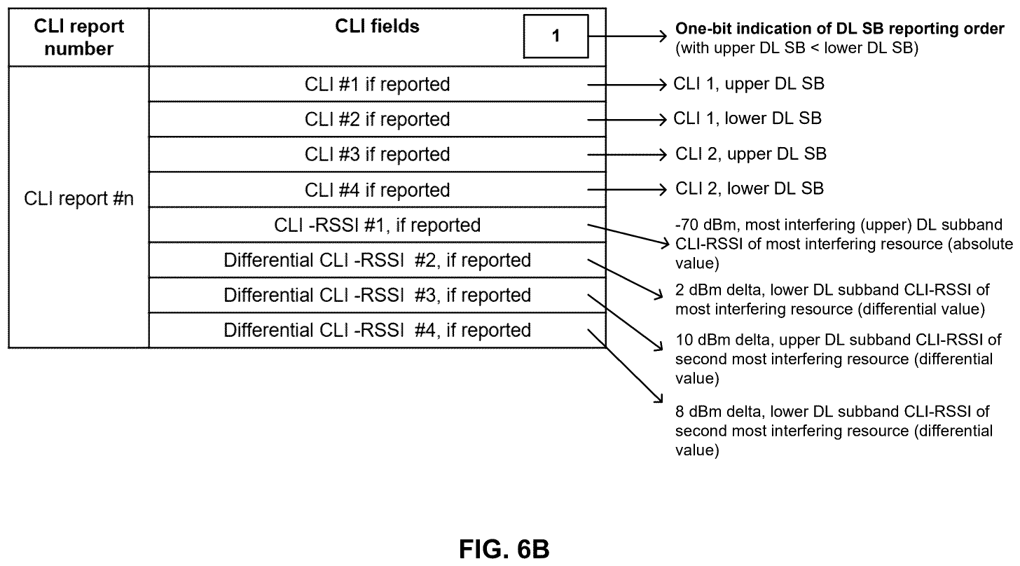

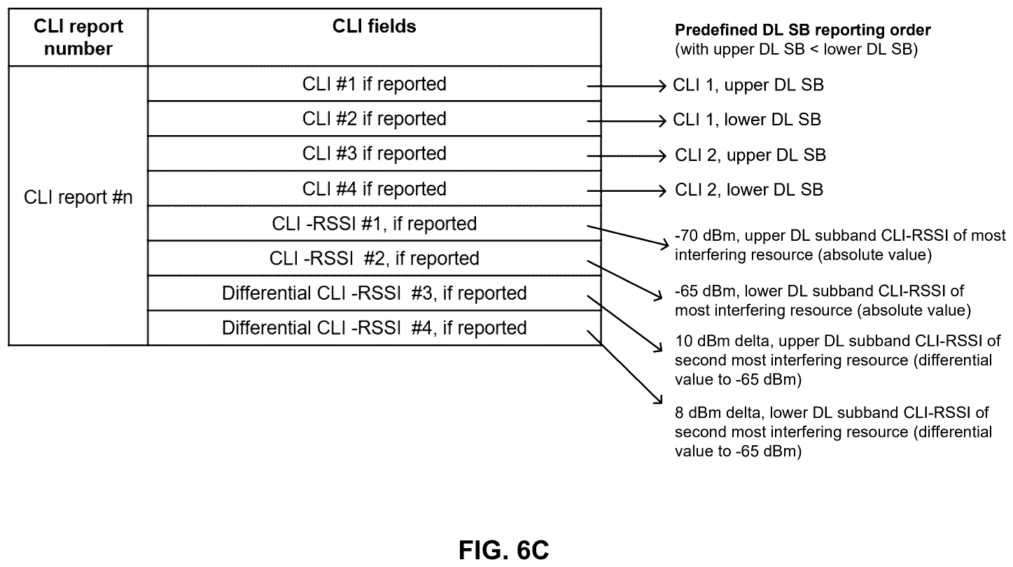

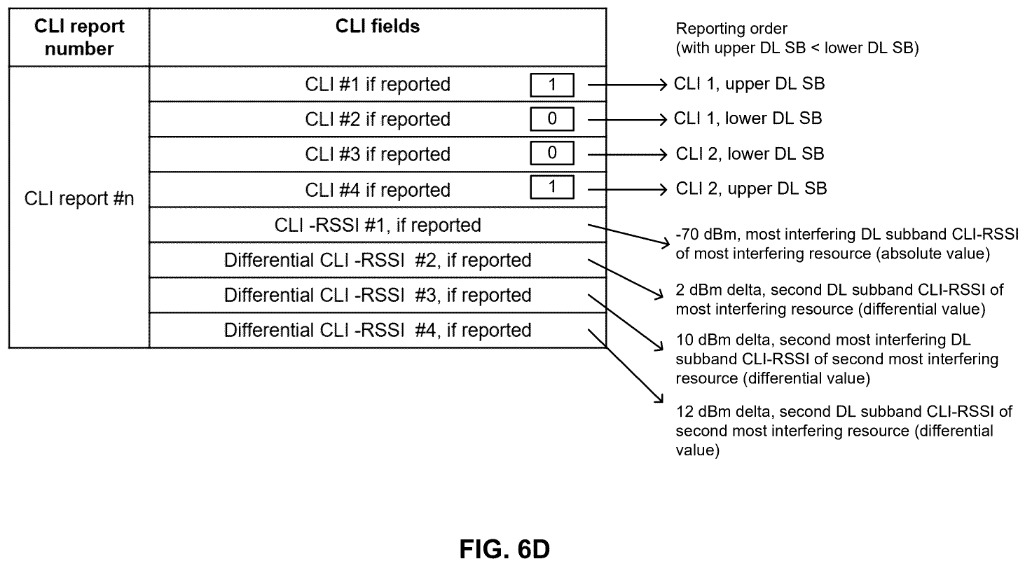

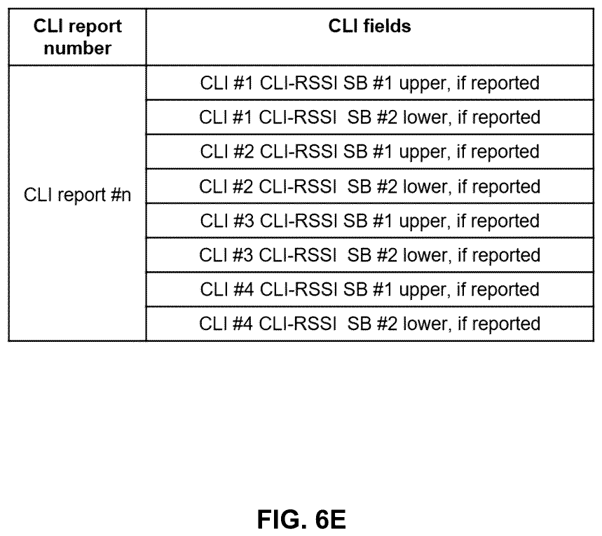

FIGS. 6A-6E are diagrams illustrating examples associated with L1 CLI reporting, in accordance with the present disclosure. As shown in FIG. 6A, an example 600 includes communication between a network node 110, a UE 120a, and a UE 120b. In some aspects, the network node 110, the UE 120a, and the UE 120b may be included in a wireless network, such as wireless communication network 100. The network node 110 and a given UE 120 may communicate via respective wireless access links, each of which may include an uplink and a downlink. In example 600, the UE 120a and the UE 120b are capable of SBFD communication.

As shown in FIG. 6A at reference 602, the UE 120a may determine one or more CLI-RSSI measurement resources in one or more SBFD symbols. A CLI-RSSI measurement resource is a measurement resource in which the UE 120a is to measure a CLI-RSSI. In some aspects, the one or more CLI-RSSI measurement resources may include one or more non-contiguous resources. As used herein, a non-contiguous resource is a resource comprising downlink subbands in frequency resources that are non-contiguous (i.e., separated in the frequency domain). As an example, a CLI-RSSI measurement resource may be a non-contiguous resource that is configured across two downlink subbands of an active downlink bandwidth part, with the two downlink subbands being separated by an uplink band or one or more guard bands (e.g., the CLI-RSSI measurement resource may be a type #2 measurement resource).

In some aspects, the UE 120a may determine a CLI-RSSI measurement resource based at least in part on excluding an uplink subband or one or more guard bands, indicated by an SBFD indication, from a contiguous resource indicated by a CLI-RSSI measurement resource configuration. For example, the UE 120 may receive, from the network node 110, a CLI-RSSI measurement resource configuration that indicates a contiguous CLI-RSSI measurement resource using a starting physical resource block (PRB) index and an integer quantity of PRBs (e.g., 4). The UE 120 may further receive, from the network node 110, an SBFD frequency configuration that indicates a frequency configuration of SBFD symbols (e.g., a frequency resource of an uplink band and frequency resources of one or more guard bands). The UE 120 may then determine the non-contiguous CLI-RSSI measurement resource by excluding the uplink subband and the one or more guard bands, as indicated by the SBFD frequency configuration indication, from the contiguous CLI-RSSI measurement resource indicated by a CLI-RSSI measurement resource configuration. In this way, the UE 120 can implicitly determine frequency resources for a given one of the CLI-RSSI measurement resources within a given active downlink bandwidth part.

In some aspects, the UE 120 may determine a plurality of CLI-RSSI measurement resources in a plurality of SBFD symbols. That is, in some aspects, the UE 120 may identify a plurality of CLI-RSSI measurement resources in SBFD symbols in which the UE 120 is to perform CLI-RSSI measurements.

As shown at reference 604, the UE 120b may transmit one or more uplink signals in the one or more CLI-RSSI resources. That is, the UE 120b may transmit uplink signals in SBFD symbols of one or more downlink subbands of an active downlink bandwidth part that correspond to the CLI-RSSI measurement resources determined by the UE 120a. As shown at reference 606, the transmission of the one or more uplink signals by the UE 120b may result in CLI at the UE 120a. Here, the CLI at the UE 120a is (inter-SB intra-cell) UE-to-UE CLI.

As shown at reference 608, the UE 120a may perform one or more CLI-RSSI measurements in the one or more CLI-RSSI measurement resources. That is, the UE 120 may measure a CLI-RSSI in each of the one or more CLI-RSSI measurement resources in the one or more SBFD symbols.

As shown at reference 610, the UE 120 may transmit a CLI report based at least in part on the one or more CLI-RSSI measurements. In some aspects, the CLI report indicates one or more measurement values associated with N (N≥1) CLI-RSSI measurement resources of the one or more CLI-RSSI measurement resources. That is, the CLI report may indicate one or more measurement values for each of N CLI-RSSI measurement resources, with the N CLI-RSSI measurement resources being selected from the one or more CLI-RSSI measurement resources in which the UE 120 measured a CLI-RSSI. N≥1 means that a number N can be one or greater than 1.

In some aspects, a quantity of CLI-RSSI measurement resources in the N CLI-RSSI measurement resources for which measurement values are reported is based at least in part on an configuration received from the network node 110. Additionally, or alternatively, the quantity of CLI-RSSI measurement resources in the N CLI-RSSI measurement resources for which measurement values are reported is based at least in part on a UE capability.

In some aspects, for a given CLI-RSSI measurement resource of the N CLI-RSSI measurement resources, the one or more measurement values may include a single wideband measurement value. The single wideband measurement value may indicate, for example, an average CLI-RSSI associated with a plurality of downlink subbands of the given CLI-RSSI measurement resource (e.g., an average of a CLI-RSSI measured in a first downlink subband in the given CLI-RSSI measurement resource and a CLI-RSSI measured in a second downlink subband of the given CLI-RSSI measurement resource). Thus, in some aspects, the CLI report may indicate N single wideband measurement values, with each single wideband measurement value of the N single wideband measurement values corresponding to respective CLI-RSSI measurement resource of the N CLI-RSSI measurement resources.

Additionally, or alternatively, for a given CLI-RSSI measurement resource of the N CLI-RSSI measurement resources, the one or more measurement values may include one or more per-downlink-subband measurement values. Each of the one or more per-downlink-subband measurement values may indicate a CLI-RSSI associated with a respective downlink subband of a plurality of downlink subbands of the given CLI-RSSI measurement resource (e.g., a CLI-RSSI measured in a first downlink subband of the CLI-RSSI measurement resource and a CLI-RSSI measured in a second downlink subband of the CLI-RSSI measurement resource). Thus, in some aspects, the CLI report may indicate N pairs of per-downlink-subband measurement values, with each pair of per-downlink-subband measurement values corresponding to a respective CLI-RSSI measurement resource of the N CLI-RSSI measurement resources. Here, one per-downlink-subband measurement value of a given pair of per-downlink-subband measurement values is associated with a first downlink subband (e.g., an upper downlink subband) of the associated CLI-RSSI measurement resource, while the other per-downlink-subband measurement value is associated with a second downlink subband (e.g., a lower downlink subband) of the associated CLI-RSSI measurement resource.

In some aspects, the one or more measurement values may include a single wideband measurement value based at least in part on an indication received from the network node 110. That is, in some aspects, the network node 110 may transmit, and the UE 120 may receive, a configuration indicating that the UE 120 is to report single wideband measurement values. Alternatively, the one or more measurement values include one or more per-downlink-subband measurement values based at least in part on an indication received from the network node 110. That is, in some aspects, the network node 110 may transmit, and the UE 120 may receive, a configuration indicating that the UE 120 is to report per-downlink-subband measurement values. In some aspects, the configuration by the network node 110 may be based at least in part on UE capability information. For example, the UE 120 may in some aspects transmit UE capability information indicating whether the UE 120 supports inter-UE CLI reporting of single wideband measurement values or whether the UE supports inter-UE CLI reporting of per-downlink-subband measurement values. That is, the UE 120 may indicate, to the network node 110, whether the UE 120 supports single wideband CLI-RSSI measurement, per-downlink-subband CLI-RSSI measurement, or both. The network node 110 may then configure the UE 120 based at least in part on the UE capability information.

In some aspects, the one or more measurement values may include single wideband measurement values according to a default rule and based at least in part on absence of a specific configuration from an L1 CLI report configuration. For example, the network node 110 may transmit, and the UE 120 may receive, an LI CLI report configuration. Here, the UE 120 may determine whether the L1 CLI report configuration indicates that the UE 120 is to report single wideband measurement values or per-downlink-subband measurement values. If the UE 120 determines that the L1 CLI report configuration does not include such an indication (e.g., that a specific configuration is absent from the L1 CLI report configuration), and the UE 120 is configured with a default rule indicating that the UE 120 is to report single wideband measurement values in the absence of a specific configuration, then the UE 120 may include single wideband measurement values in the CLI report.

Alternatively, the one or more measurement values may include one or more per-downlink-subband measurement values according to a default rule and based at least in part on absence of a specific configuration from an L1 CLI report configuration. For example, the network node 110 may transmit, and the UE 120 may receive, an LI CLI report configuration. Here, the UE 120 may determine whether the L1 CLI report configuration indicates that the UE 120 is to report single wideband measurement values or per-downlink-subband measurement values. If the UE 120 determines that the L1 CLI report configuration does not include such an indication (e.g., that a specific configuration is absent from the L1 CLI report configuration), and the UE 120 is configured with a default rule indicating that the UE 120 is to report per-downlink-subband measurement values in the absence of a specific configuration, then the UE 120 may include per-downlink-subband measurement values in the CLI report.

In some aspects, the one or more measurement values may include single wideband measurement values based at least in part on a preconfiguration of the UE 120. For example, an applicable wireless communication standard may include a rule specifying that CLI reports for inter-UE CLI measured in SBFD symbols are to include single wideband measurement values, and the UE 120 may be preconfigured according to the rule. Alternatively, the one or more measurement values may include per-downlink-subband measurement values based at least in part on a preconfiguration of the UE 120. For example, an applicable wireless communication standard may include a rule specifying that CLI reports for inter-UE CLI measured in SBFD symbols are to include per-downlink-subband measurement values, and the UE 120 may be preconfigured according to the rule.

In some aspects, the N CLI-RSSI measurement resources for which the UE 120 reports measurement values are an N most interfering resources of the one or more CLI-RSSI measurement resources in which the UE 120 measures CLI-RSSIs. That is, in some aspects, the UE 120 may be configured to report CLI-RSSIs for the N CLI-RSSI measurement resources in which the most CLI is measured.

In some aspects, the N CLI-RSSI measurement resources may include the N most interfering resources of the one or more CLI-RSSI measurement resources based at least in part on a preconfiguration of the UE 120. For example, an applicable wireless communication standard may specify that CLI reports for inter-UE CLI measured in SBFD symbols are to include measurement values for an N most interfering resources among CLI-RSSI measurement resources measured by the UE 120. Here, the UE 120 may be preconfigured to generate and transmit CLI reports for inter-UE CLI measured in SBFD symbols that include measurement values for an N most interfering resources among CLI-RSSI measurement resources measured by the UE 120, according to the applicable wireless communication standard.

Additionally, or alternatively, the N CLI-RSSI measurement resources may include the N most interfering resources of the one or more CLI-RSSI measurement resources based at least in part on an L1 CLI report configuration received from the network node 110. For example, the network node 110 may transmit, and the UE 120 may receive, an L1 CLI report configuration indicating that the UE 120 is to include measurement values for an N most interfering resources among CLI-RSSI measurement resources measured by the UE 120, and the UE 120 may generate and transmit the CLI report according to the L1 CLI report configuration.

Additionally, or alternatively, the N CLI-RSSI measurement resources may include an N most interfering resources of the one or more CLI-RSSI measurement resources according to a default rule and based at least in part on absence of a specific configuration from an L1 CLI report configuration. For example, the network node 110 may transmit, and the UE 120 may receive, an LI CLI report configuration. Here, the UE 120 may determine whether the L1 CLI report configuration specifies a manner in which the N CLI-RSSI measurement resources to be reported by the UE 120 is indicated in the L1 CLI report. If the UE 120 determines that the L1 CLI report configuration does not include such an indication (e.g., that the L1 CLI report configuration does not indicate a manner in which the UE 120 is to determine the N CLI-RSSI measurement resources), and the UE 120 is configured with a default rule indicating that the UE 120 is to report an N most interfering resources in the absence of a specific configuration, then the UE 120 may report measurement values for the N most interfering CLI-RSSI measurement resources according to the default rule configured on the UE 120.

Alternatively, in some aspects, the N CLI-RSSI measurement resources for which the UE 120 reports measurement values are an N least interfering resources of the one or more CLI-RSSI measurement resources in which the UE 120 measures CLI-RSSIs. That is, in some aspects, the UE 120 may be configured to report CLI-RSSIs for the N CLI-RSSI measurement resources in which the least CLI is measured.

In some aspects, the N CLI-RSSI measurement resources may include the N least interfering resources of the one or more CLI-RSSI measurement resources based at least in part on a preconfiguration of the UE 120. For example, an applicable wireless communication standard may specify that CLI reports for inter-UE CLI measured in SBFD symbols are to include measurement values for an N least interfering resources among CLI-RSSI measurement resources measured by the UE 120. Here, the UE 120 may be preconfigured to generate and transmit CLI reports for inter-UE CLI measured in SBFD symbols that include measurement values for an N least interfering resources among CLI-RSSI measurement resources measured by the UE 120, according to the applicable wireless communication standard.

Additionally, or alternatively, the N CLI-RSSI measurement resources may include the N least interfering resources of the one or more CLI-RSSI measurement resources based at least in part on an L1 CLI report configuration received from the network node 110. For example, the network node 110 may transmit, and the UE 120 may receive, an L1 CLI report configuration indicating that the UE 120 is to include measurement values for an N least interfering resources among CLI-RSSI measurement resources measured by the UE 120, and the UE 120 may generate and transmit the CLI report according to the L1 CLI report configuration.

Additionally, or alternatively, the N CLI-RSSI measurement resources may include an N least interfering resources of the one or more CLI-RSSI measurement resources according to a default rule and based at least in part on absence of a specific configuration from an L1 CLI report configuration. For example, the network node 110 may transmit, and the UE 120 may receive, an LI CLI report configuration. Here, the UE 120 may determine whether the L1 CLI report configuration specifies a manner in which the N CLI-RSSI measurement resources to be reported by the UE 120 is indicated in the L1 CLI report. If the UE 120 determines that the L1 CLI report configuration does not include such an indication (e.g., that the L1 CLI report configuration does not indicate a manner in which the UE 120 is to determine the N CLI-RSSI measurement resources), and the UE 120 is configured with a default rule indicating that the UE 120 is to report an N least interfering resources in the absence of a specific configuration, then the UE 120 may report measurement values for the N least interfering CLI-RSSI measurement resources according to the default rule configured on the UE 120.

In some aspects, the UE 120 may transmit UE capability information indicating that the UE 120 supports only a downlink/uplink (D/U) subband frequency configuration in SBFD symbols. That is, the UE 120 may indicate, to the network node 110, the UE 120 does not support downlink/uplink/downlink (D/U/D) subband frequency configuration in SBFD symbols. In such a scenario, if a CLI-RSSI measurement resource is a non-contiguous resource, then the UE 120 may perform CLI-RSSI measurement in a single downlink subband of the (non-contiguous) CLI-RSSI measurement resource, and may include a measurement value associated with the CLI-RSSI measurement in the single downlink subband in a CLI report. That is, the UE 120 may in some aspects transmit UE capability information indicating that the UE 120 supports only a D/U configuration for SBFD symbols. The UE 120 may then perform CLI-RSSI measurement in only one downlink subband within the active downlink bandwidth part (while ignoring other downlink subband of with respect to CLI-RSSI), and may transmit a CLI report including a measurement value associated with the CLI-RSSI measurement performed in the single downlink subband.

Additionally, or alternatively, the UE 120 may transmit UE capability information indicating that the UE supports a downlink/uplink/downlink (D/U/D) subband frequency configuration in SBFD symbols. In such a scenario, if a CLI-RSSI measurement resource is a non-contiguous resource, then the UE 120 may perform CLI-RSSI measurements in each downlink subband of the (non-contiguous) CLI-RSSI measurement resource, and may include one or more measurement values associated with the CLI-RSSI measurements performed in each of the downlink subbands in a CLI report.

In some aspects, the UE 120 may transmit, and the network node 110 may receive, UE capability information indicating whether the UE 120 supports CLI-RSSI measurements in CLI-RSSI measurement resources configured within single downlink subbands (e.g., measurement resource type #1), CLI-RSSI measurements in CLI-RSSI measurement resources configured across multiple downlink subbands (e.g., measurement resource type #2), or both. In some aspects, the network node 110 may configure the UE 120 based at least in part on such UE capability information. For example, the network node 110 may generate a CLI-RSSI measurement resource configuration or an SBFD frequency configuration based at least in part on the UE capability information, and may transmit the CLI-RSSI measurement resource configuration or the SBFD frequency configuration to the UE 120.

In some aspects, the N CLI-RSSI measurement resources may be ordered within the CLI report based at least in part on a maximum CLI-RSSI, with the maximum CLI-RSSI being a maximum CLI-RSSI of one downlink subband of a plurality of downlink subbands per each CLI-RSSI measurement resource of the one or more CLI-RSSI measurement resources. That is, the UE 120 may determine a downlink subband, from among all downlink subbands of all measured CLI-RSSI measurement resources, in which a maximum CLI-RSSI was measured by the UE 120. The UE 120 may identify a particular CLI-RSSI measurement resource associated with the maximum CLI-RSSI, and may order the N CLI-RSSI measurement resources within the CLI accordingly (e.g., such that the CLI-RSSI measurement resource including the downlink subband with the maximum CLI-RSSI is reported first within the CLI report). Examples regarding ordering of the N CLI-RSSI measurement resources within the CLI report based at least in part on the maximum CLI-RSSI are provided below with respect to FIGS. 6B-6E.

Alternatively, the N CLI-RSSI measurement resources may be ordered within the CLI report based at least in part on a minimum CLI-RSSI, with the minimum CLI-RSSI being a minimum CLI-RSSI of one downlink subband of a plurality of downlink subbands per each CLI-RSSI measurement resource of the one or more CLI-RSSI measurement resources. That is, the UE 120 may determine a downlink subband, from among all downlink subbands of all measured CLI-RSSI measurement resources, in which a minimum CLI-RSSI was measured by the UE 120. The UE 120 may identify a particular CLI-RSSI measurement resource associated with the minimum CLI-RSSI, and may order the N CLI-RSSI measurement resources within the CLI accordingly (e.g., such that the CLI-RSSI measurement resource including the downlink subband with the minimum CLI-RSSI is reported first within the CLI report).

In some aspects, when the one or more measurement values include a plurality of per-downlink-subband measurement values, the CLI report may comprise a plurality of CLI-RSSI measurement resource indicator fields and a plurality of per-downlink-subband measurement value fields. In some such aspects, each CLI-RSSI measurement resource indicator field of the plurality of CLI-RSSI measurement resource indicator fields maps to a respective per-downlink-subband measurement value field of the plurality of per-downlink-subband measurement value fields. FIGS. 6B-6D illustrate examples of such a CLI report. Taking the CLI report shown in FIG. 6B as an example a first CLI-RSSI measurement resource indicator field (CLI #1) maps to a first per-downlink-subband measurement value field (CLI-RSSI #1), a second CLI-RSSI measurement resource indicator field (CLI #2) maps to a second per-downlink-subband measurement value field (Differential CLI-RSSI #2), a third CLI-RSSI measurement resource indicator field (CLI #3) maps to a third per-downlink-subband measurement value field (Differential CLI-RSSI #3), and a fourth CLI-RSSI measurement resource indicator field (CLI #4) maps to a fourth per-downlink-subband measurement value field (Differential CLI-RSSI #4). In other words, each CLI-RSSI measurement resource indicator field maps to a different per-downlink-subband measurement value field. The examples shown in FIGS. 6C-6D have a similar mapping.

In some aspects, when the CLI report includes a plurality of per-downlink-subband measurement values, the CLI report may include a one-bit indication that indicates a reporting order of an upper downlink subband and a lower downlink subband per-downlink-subband measurement values associated with a given CLI measurement resource. That is, in some aspects, the CLI report may include a one-bit indication to indicate an order of downlink subbands associated with CLI-RSSI measurement resources reported in the CLI report (e.g., an order in which an upper downlink subband and a lower downlink subband are presented for each of the N CLI-RSSI measurement resources in the CLI report). In some aspects, the reporting order may be based at least in part on a most interfering subband of a most interfering CLI-RSSI measurement resource of the one or more CLI-RSSI measurement resources. That is, the order in which the N CLI-RSSI measurement resources are reported in the CLI may be determined by the UE 120 such that the first reported per-downlink-subband measurement value reported in the CLI report is for a most interfering downlink subband of a most interfering CLI-RSSI measurement resource among all measured downlink subbands of the one or more CLI-RSSI measurement resources measured by the UE 120. Alternatively, the reporting order may be based at least in part on a least interfering subband of a least interfering CLI-RSSI measurement resource of the one or more CLI-RSSI measurement resources. That is, the order in which the N CLI-RSSI measurement resources are reported in the CLI may in some aspects be determined by the UE 120 such that the first reported per-downlink-subband measurement value reported in the CLI report is for a least interfering downlink subband of a least interfering CLI-RSSI measurement resource among all measured downlink subbands of the one or more CLI-RSSI measurement resources measured by the UE 120. In some aspects, a per-downlink-subband measurement value field of the plurality of per-downlink-subband measurement value fields indicates an absolute value, and other per-downlink-subband measurement value fields of the plurality of per-downlink-subband measurement value fields indicate differential values relative to the absolute value. That is, in some aspects, a first per-downlink-subband measurement value field may indicate an absolute value corresponding to a per-downlink-subband measurement value (e.g., a per-downlink-subband measurement value of a most interfering downlink subband of a most interfering CLI-RSSI measurement resource, or a per-downlink-subband measurement value of a least interfering downlink subband of a least interfering CLI-RSSI measurement resource), while other per-downlink-subband measurement value fields may indicate differential values relative to the absolute value indicated in the first per-downlink-subband measurement value field.

FIG. 6B is a diagram illustrating an example of a CLI reporting that includes a plurality of CLI-RSSI measurement resource indicator fields that map to a plurality of per-downlink-subband measurement value fields and a one-bit indication that indicates a reporting order of an upper downlink subband and a lower downlink subband per-downlink-subband measurement value associated with a given CLI measurement resource, where the reporting order is based at least in part on a most interfering subband of a most interfering CLI-RSSI measurement resource of the one or more CLI-RSSI measurement resources and the measurement values are reported using one absolute value and a plurality of differential values. In the example shown in FIG. 6B, the CLI report (CLI report #n) includes a plurality of CLI-RSSI measurement resource indicator fields including CLI #1, CLI #2, CLI #3, and CLI #4, and a plurality of per-downlink-subband measurement value fields including CLI-RSSI #1, Differential CLI-RSSI #2, Differential CLI-RSSI #3, and Differential CLI-RSSI #4. Here, field CLI #1 maps to field CLI-RSSI #1, field CLI #2 maps to field Differential CLI-RSSI #2, field CLI #3 maps to field Differential CLI-RSSI #3, and field CLI #4 maps to field Differential CLI-RSSI #4.

In this example, the UE 120 has determined that an upper downlink subband of a first CLI-RSSI measurement resource (CLI 1) is the most interfering subband of the most interfering CLI-RSSI measurement resource (e.g., −70 decibel-milliwatts (dBm)) among CLI-RSSI measurement resources measured by the UE 120. Therefore, the UE 120 reports an absolute value of the CLI-RSSI measured in the upper subband of CLI 1in field CLI-RSSI #1, and includes a CLI-RSSI measurement resource indicator associated with CLI 1 (e.g., an CLI-RSSI measurement resource index value) in the associated indicator field CLI #1. As further shown, the UE 120 reports a differential value (e.g., 2 dB relative to the absolute value indicated in field CLI-RSSI #1) of a CLI-RSSI measured in the lower subband of CLI 1 (i.e., the other subband associated with CLI 1) in field CLI-RSSI #2, and includes the CLI-RSSI measurement resource indicator associated with CLI 1 in the associated indicator field CLI #2. As further shown, the UE 120 reports a differential value (e.g., 10 dB relative to the absolute value indicated in field CLI-RSSI #1) of a CLI-RSSI measured in an upper subband of a second most interfering CLI-RSSI measurement resource (identified as CLI 2) in field CLI-RSSI #3, and includes the CLI-RSSI measurement resource indicator associated with CLI 2 in the associated indicator field CLI #3. As further shown, the UE 120 reports a differential value (e.g., 8 dB relative to the absolute value indicated in field CLI-RSSI #1) of a CLI-RSSI measured in the lower subband of CLI 2 (i.e., the other subband associated with CLI 2) in field CLI-RSSI #4, and includes the CLI-RSSI measurement resource indicator associated with CLI 2 in the associated indicator field CLI #4.

As further shown, the CLI report includes a one-bit indication set to a first value (e.g., 1) to indicate that, within the CLI report, an upper subband associated with a given CLI-RSSI measurement resource is reported before a lower subband associated with the given CLI-RSSI measurement resource. In a scenario in which a lower DL subband is the most interfering subband of the most interfering CLI-RSSI measurement resource the one-bit indication would be set to a second value (e.g., 0) to indicate that, within the CLI report, a lower subband associated with a given CLI-RSSI measurement resource is reported before an upper subband associated with the given CLI-RSSI measurement resource. In some aspects, the use of the one-bit indication minimizes overhead associated with enabling determination of a reporting order of per-downlink-subband measurement values per CLI-RSSI measurement resource within the CLI report.

Notably, in the example shown in FIG. 6B, the most interfering subband associated with CLI-RSSI measurement resource CLI 2 is the lower subband, meaning that the per-downlink-subband measurement values are not reported in descending order (because the order of upper/lower subband reporting is dictated by the most interfering subband of the most interfering CLI-RSSI measurement resource, which in this example is the upper subband of CLI-RSSI measurement resource CLI 1).

In some aspects, when the CLI report includes a plurality of per-downlink-subband measurement values, per-downlink-subband measurement values, associated with a given CLI measurement resource indicator field of the plurality of CLI measurement resource indicators fields, are ordered within the CLI report according to a predefined downlink subband order. For example, the CLI report may include two absolute values with a defined order (e.g., upper downlink subband followed by lower downlink subband, or lower downlink subband followed by upper downlink subband) of a most interfering CLI-RSSI measurement resource among the one or more CLI-RSSI measurement resources measured by the UE 120. In this example, the CLI report may include differential values in the defined order associated with other CLI-RSSI measurement resources of N CLI-RSSI measurement resources reported by the UE 120. Thus, in some aspects, a first per-downlink-subband measurement value field of the plurality of per-downlink-subband measurement value fields indicates a first absolute value, a second per-downlink-subband measurement value field of the plurality of per-downlink-subband measurement value fields indicates a second absolute value, and other per-downlink-subband measurement value fields of the plurality of per-downlink-subband measurement value fields indicate differential values relative to the first absolute value or relative to the second absolute value.

In some aspects, a determination of the CLI-RSSI measurement resource, of the N CLI-RSSI measurement resources, reported as the first absolute value and the second absolute value may be based at least in part on a downlink subband of the CLI-RSSI measurement resource being a most interfering subband of a most interfering CLI-RSSI measurement resource of the one or more CLI-RSSI measurement resources. Alternatively, the determination of the CLI-RSSI measurement resource, of the N CLI-RSSI measurement resources, reported as the first absolute value and the second absolute value may be based at least in part on a downlink subband of the CLI-RSSI measurement resource being a least interfering subband of a least interfering CLI-RSSI measurement resource of the one or more CLI-RSSI measurement resources.

FIG. 6C is a diagram illustrating an example of a CLI reporting that includes a plurality of CLI-RSSI measurement resource indicator fields that map to a plurality of per-downlink-subband measurement value fields, where a reporting order associated with downlink subbands of a given CLI-RSSI measurement resource is predefined such that the UE 120 is to report upper downlink subbands followed by lower downlink subbands. In this example, the UE 120 is configured such that a CLI-RSSI measurement resource reported as the first absolute value and the second absolute value is based at least in part on the most interfering subband of the most interfering CLI-RSSI measurement resource of the one or more CLI-RSSI measurement resources measured by the UE 120. In the example shown in FIG. 6C, the CLI report (CLI report #n) includes a plurality of CLI-RSSI measurement resource indicator fields including CLI #1, CLI #2, CLI #3, and CLI #4, and a plurality of per-downlink-subband measurement value fields including CLI-RSSI #1, CLI-RSSI #2, Differential CLI-RSSI #3, and Differential CLI-RSSI #4. Here, field CLI #1 maps to field CLI-RSSI #1, field CLI #2 maps to field CLI-RSSI #2, field CLI #3 maps to field Differential CLI-RSSI #3, and field CLI #4 maps to field Differential CLI-RSSI #4.

In this example, the UE 120 has determined that a lower downlink subband of a first CLI-RSSI measurement resource (CLI 1) is the most interfering subband of the most interfering CLI-RSSI measurement resource (e.g., −65 dBm) among CLI-RSSI measurement resources measured by the UE 120. Therefore, the UE 120 reports an absolute value of the CLI-RSSI measured in the lower subband of CLI 1 in field CLI-RSSI #2, and includes a CLI-RSSI measurement resource indicator associated with CLI 1 (e.g., an CLI-RSSI measurement resource index value) in the associated indicator field CLI #2. As further shown, the UE 120 reports an absolute value (e.g., −70 dBm) of a CLI-RSSI measured in the upper subband of CLI 1 (i.e., the other subband associated with CLI 1) in field CLI-RSSI #1, and includes the CLI-RSSI measurement resource indicator associated with CLI 1 in the associated indicator field CLI #1. As further shown, the UE 120 reports a differential value (e.g., 10 dB relative to the absolute value of −65 dBm indicated in field CLI-RSSI #2) of a CLI-RSSI measured in a upper subband of a second most interfering CLI-RSSI measurement resource (identified as CLI 2) in field CLI-RSSI #3, and includes the CLI-RSSI measurement resource indicator associated with CLI 2 in the associated indicator field CLI #3. As further shown, the UE 120 reports a differential value (e.g., 8 dB relative to the absolute value of −65 dBm indicated in field CLI-RSSI #2) of a CLI-RSSI measured in the lower subband of CLI 2 (i.e., the other subband associated with CLI 2) in field CLI-RSSI #4, and includes the CLI-RSSI measurement resource indicator associated with CLI 2 in the associated indicator field CLI #4.

In some aspects, when the CLI report includes a plurality of per-downlink-subband measurement values, the CLI report includes a one-bit indication for each CLI-RSSI measurement resource indicator field. For example, the CLI report may include a first one-bit indication that indicates a downlink subband, of a plurality of downlink subbands associated with a given CLI-RSSI measurement resource, that is associated with a first CLI-RSSI measurement resource indicator field of the plurality of CLI-RSSI measurement resource indicator fields, and may include a second one-bit indication that indicates another downlink subband, of the plurality of downlink subbands associated with the given CLI-RSSI measurement resource, that is associated with a second CLI-RSSI measurement resource indicator field of the plurality of CLI-RSSI measurement resource indicator fields, and so on. Put another way, the one bit per CLI resource indicator in the CLI report may be used to indicate whether the associated per-downlink-subband measurement value is for a lower downlink subband of the associated CLI-RSSI measurement resource or for an upper downlink subband of the associated CLI-RSSI measurement resource. In some such aspects, one per-downlink-subband measurement value field indicates an absolute value and other per-downlink-subband measurement value fields indicate differential values relative to the absolute value.

FIG. 6D is a diagram illustrating an example of a CLI reporting that includes a plurality of CLI-RSSI measurement resource indicator fields that map to a plurality of per-downlink-subband measurement value fields, where each CLI-RSSI measurement resource indicator field includes a one-bit indication that indicates whether the associated per-downlink-subband measurement value field is associated with an upper downlink subband of a given CLI-RSSI measurement resource or a lower downlink subband of the given CLI-RSSI measurement resource and the measurement values are reported using one absolute value and a plurality of differential values. In the example shown in FIG. 6D, the CLI report (CLI report #n) includes a plurality of CLI-RSSI measurement resource indicator fields including CLI #1, CLI #2, CLI #3, and CLI #4, and a plurality of per-downlink-subband measurement value fields including CLI-RSSI #1, Differential CLI-RSSI #2, Differential CLI-RSSI #3, and Differential CLI-RSSI #4. Here, field CLI #1 maps to field CLI-RSSI #1, field CLI #2 maps to field Differential CLI-RSSI #2, field CLI #3 maps to field Differential CLI-RSSI #3, and field CLI #4 maps to field Differential CLI-RSSI #4.

In this example, the UE 120 has determined that an upper downlink subband of a first CLI-RSSI measurement resource (CLI 1) is the most interfering subband (e.g., −70 dBm) among subbands of CLI-RSSI measurement resources measured by the UE 120. Therefore, the UE 120 reports an absolute value of the CLI-RSSI measured in the upper subband of CLI 1 in field CLI-RSSI #1, and includes a CLI-RSSI measurement resource indicator associated with CLI 1 (e.g., an CLI-RSSI measurement resource index value) in the associated indicator field CLI #1, along with a one-bit indicator (e.g., a value of 1) indicating that the reported measurement value is for an upper subband. Further, in this example, the UE 120 has determined that a lower downlink subband of CLI 1 is the second most interfering subband among subbands of CLI-RSSI measurement resources measured by the UE 120. Therefore, the UE 120 reports a differential value (e.g., 2 dBm relative to the absolute value of −70 dBm indicated in field CLI-RSSI #1) associated with the CLI-RSSI measured in the lower subband of CLI 1 in field Differential CLI-RSSI #2, and includes a CLI-RSSI measurement resource indicator associated with CLI 1 in the associated indicator field CLI #2, along with a one-bit indicator (e.g., a value of 0) indicating that the reported measurement value is for a lower subband. Further, in this example, the UE 120 has determined that a lower downlink subband of CLI 2 is the third most interfering subband among subbands of CLI-RSSI measurement resources measured by the UE 120. Therefore, the UE 120 reports a differential value (e.g., 10 dBm relative to the absolute value of −70 dBm indicated in field CLI-RSSI #1) associated with the CLI-RSSI measured in the lower subband of CLI 2 in field Differential CLI-RSSI #3, and includes a CLI-RSSI measurement resource indicator associated with CLI 2 in the associated indicator field CLI #3, along with a one-bit indicator (e.g., a value of 0) indicating that the reported measurement value is for a lower subband.

Further in this example, the UE 120 has determined that an upper downlink subband of CLI 2 is the fourth most interfering subband among subbands of CLI-RSSI measurement resources measured by the UE 120. Therefore, the UE 120 reports a differential value (e.g., 12 dBm relative to the absolute value of −70 dBm indicated in field CLI-RSSI #1) associated with the CLI-RSSI measured in the upper subband of CLI 2 in field Differential CLI-RSSI #4, and includes a CLI-RSSI measurement resource indicator associated with CLI 2 in the associated indicator field CLI #4, along with a one-bit indicator (e.g., a value of 1) indicating that the reported measurement value is for an upper subband.

In some aspects, the CLI report may include a plurality of per-downlink-subband measurement value fields, with each per-downlink-subband measurement value field indicating a per-downlink-subband measurement value corresponding to a respective downlink or uplink subband. That is, in some aspects, the CLI may include a per-downlink-subband measurement value, reported as an absolute value, for each downlink subband of each of the N CLI-RSSI measurement resources. Here, a reporting order of downlink subbands for a given CLI-RSSI measurement resource may be the upper downlink subband followed by the lower downlink subband, or may be the lower downlink subband followed by the upper downlink subband. In some aspects, the order in which the upper and lower downlink subbands are reported may be preconfigured on the UE 120 (e.g., according to a rule specified in applicable wireless communication standard). Thus, in some aspects, the CLI report includes a plurality of per-downlink-subband measurement value fields, where a first per-downlink-subband measurement value field of the plurality of per-downlink-subband measurement value fields indicates a per-downlink-subband measurement value corresponding to a first downlink subband of a given CLI measurement resource, and a second per-downlink-subband measurement value field of the plurality of per-downlink-subband measurement value fields indicates a per-downlink-subband measurement value corresponding to a second downlink subband of the given CLI measurement resource. Here, as noted above, the first downlink subband may in some aspects be an upper downlink subband and the second downlink subband may be a lower downlink subband, or the first downlink subband may be the lower downlink subband and the second downlink subband may be the upper downlink subband (e.g., according to a downlink subband reporting order preconfigured on the UE 120).

FIG. 6E is a diagram illustrating an example of a CLI reporting that includes a plurality of per-downlink-subband measurement value fields, where each per-downlink-subband measurement value field is to carry an absolute value of a per-downlink-subband measurement value associated with a respective CLI-RSSI measurement resource. In the example shown in FIG. 6E, the CLI report (CLI report #n) includes a plurality of CLI-RSSI measurement resource per-downlink-subband measurement value fields including CLI #1 CLI-RSSI SB #1 upper, CLI #1 CLI-RSSI SB #2 lower, CLI #2 CLI-RSSI SB #1 upper, CLI #2 CLI-RSSI SB #2 lower, CLI #3 CLI-RSSI SB #1 upper, CLI #3 CLI-RSSI SB #2 lower, CLI #4 CLI-RSSI SB #1 upper, and CLI #1 CLI-RSSI SB #2 upper. In this example, the UE 120 is preconfigured to report upper downlink subbands followed by lower downlink subbands. Thus, in this example, the CLI report includes a first per-downlink-subband measurement value associated with an upper subband of CLI 1 in field CLI #1 CLI-RSSI SB #1 upper, a second per-downlink-subband measurement value associated with a lower subband of CLI 1 in field CLI #1 CLI-RSSI SB #2 lower, a third per-downlink-subband measurement value associated with an upper subband of CLI 2 in field CLI #2 CLI-RSSI SB #1 upper, a fourth per-downlink-subband measurement value associated with a lower subband of CLI 2 in field CLI #2 CLI-RSSI SB #2 lower, a fifth per-downlink-subband measurement value associated with an upper subband of CLI 3 in field CLI #3 CLI-RSSI SB #1 upper, a sixth per-downlink-subband measurement value associated with a lower subband of CLI 3 in field CLI #3 CLI-RSSI SB #2 lower, a seventh per-downlink-subband measurement value associated with an upper subband of CLI 4 in field CLI #4 CLI-RSSI SB #1 upper, and an eighth per-downlink-subband measurement value associated with a lower subband of CLI 4 in field CLI #4 CLI-RSSI SB #2 lower, with each field carrying an absolute value.

In some aspects, the UE 120 may be configured such that the UE 120 reports a single downlink subband associated with a given CLI-RSSI measurement resource in the CLI report. That is, in some aspects, the CLI report indicates a single per-downlink-subband measurement value associated with each CLI-RSSI measurement resource of the N CLI-RSSI measurement resources. In some aspects, the single per-downlink-subband measurement value associated with a given CLI-RSSI measurement resource may correspond to a maximum CLI-RSSI of a plurality of CLI-RSSIs associated with the plurality of downlink subbands of the CLI-RSSI measurement resource (e.g., a maximum CLI-RSSI measured among two downlink subband associated with the CLI-RSSI measurement resource). Alternatively, the single per-downlink-subband measurement value associated with a given CLI-RSSI measurement resource may correspond to a minimum CLI-RSSI of a plurality of CLI-RSSIs associated with the plurality of downlink subbands of the CLI-RSSI measurement resource (e.g., a minimum CLI-RSSI measured among two downlink subbands associated with the CLI-RSSI measurement resource). Alternatively, the single per-downlink-subband measurement value associated with a given CLI-RSSI measurement resource may correspond to an average CLI-RSSI of a plurality of CLI-RSSIs associated with the plurality of downlink subbands of the CLI-RSSI measurement resource (e.g., an average of CLI-RSSIs measured among two downlink subbands associated with the CLI-RSSI measurement resource). In some aspects, the CLI report indicates one absolute value and one or more differential values, where each of the one or more differential values indicates a single per-downlink-subband measurement value associated with another CLI-RSSI measurement resource of the N CLI-RSSI measurement resources relative to the absolute value (e.g., in a manner similar to that described above with respect to FIGS. 6B-6D).

As indicated above, FIG. 6A-6E is provided as examples. Other examples may differ from what is described with respect to FIG. 6A-6E. For example, the reported values and formats shown in FIGS. 6B-6E are provided as examples for the purpose of illustration, and other values and formats may be implemented in practice.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with L1-based CLI reporting.

As shown in FIG. 7, in some aspects, process 700 may include performing one or more CLI-RSSI measurements in one or more CLI-RSSI measurement resources in one or more SBFD symbols (block 710). For example, the UE (e.g., using communication manager 806, depicted in FIG. 8) may perform one or more CLI-RSSI measurements in one or more CLI-RSSI measurement resources in one or more SBFD symbols, as described above.

As further shown in FIG. 7, in some aspects, process 700 may include transmitting a CLI report based at least in part on the one or more CLI-RSSI measurements, where the CLI report indicates one or more measurement values associated with a first number N (N≥1) CLI-RSSI measurement resources of the one or more CLI-RSSI measurement resources, the one or more measurement values including at least one of: a single wideband measurement value indicating an average CLI-RSSI associated with a plurality of downlink subbands of a CLI-RSSI measurement resource of the N CLI-RSSI measurement resources, or one or more per-downlink-subband measurement values indicating one or more CLI-RSSIs associated with one or more downlink subbands of the plurality of downlink subbands of the CLI-RSSI measurement resource of the N CLI-RSSI measurement resources (block 720). For example, the UE (e.g., using transmission component 804 and/or communication manager 806, depicted in FIG. 8) may transmit a CLI report based at least in part on the one or more CLI-RSSI measurements, where the CLI report indicates one or more measurement values associated with N (N≥1) CLI-RSSI measurement resources of the one or more CLI-RSSI measurement resources, the one or more measurement values including at least one of: a single wideband measurement value indicating an average CLI-RSSI associated with a plurality of downlink subbands of a CLI-RSSI measurement resource of the N CLI-RSSI measurement resources, or one or more per-downlink-subband measurement values indicating one or more CLI-RSSIs associated with one or more downlink subbands of the plurality of downlink subbands of the CLI-RSSI measurement resource of the N CLI-RSSI measurement resources, as described above.

Process 700 may include additional aspects, such as any single aspect or any combination of aspects described below and/or in connection with one or more other processes described elsewhere herein.

In a first aspect, the one or more CLI-RSSI measurement resources comprise one or more non-contiguous CLI-RSSI measurement resources.

In a second aspect, alone or in combination with the first aspect, the one or more measurement values include the single wideband measurement value based at least in part on an indication received from a network node.

In a third aspect, alone or in combination with one or more of the first and second aspects, the one or more measurement values include the one or more per-downlink-subband measurement values based at least in part on an indication received from a network node.

In a fourth aspect, alone or in combination with one or more of the first through third aspects, the one or more measurement values include the single wideband measurement value based at least in part on a preconfiguration of the UE.

In a fifth aspect, alone or in combination with one or more of the first through fourth aspects, the one or more measurement values include the one or more per-downlink-subband measurement values based at least in part on a preconfiguration of the UE.

In a sixth aspect, alone or in combination with one or more of the first through fifth aspects, the one or more measurement values include the single wideband measurement value according to a default rule and based at least in part on absence of a specific configuration from a layer 1 CLI report configuration.

In a seventh aspect, alone or in combination with one or more of the first through sixth aspects, the one or more measurement values include the one or more per-downlink-subband measurement values according to a default rule and based at least in part on absence of a specific configuration from a layer 1 CLI report configuration.

In an eighth aspect, alone or in combination with one or more of the first through seventh aspects, process 700 includes determining a CLI-RSSI measurement resource, of the one or more CLI-RSSI measurement resources, based at least in part on excluding an uplink subband and one or more guard bands, indicated by an SBFD frequency configuration indication, from a contiguous CLI-RSSI measurement resource indicated by a CLI-RSSI measurement resource configuration.

In a ninth aspect, alone or in combination with one or more of the first through eighth aspects, process 700 includes transmitting UE capability information indicating whether the UE supports inter-UE CLI reporting of single wideband measurement values or whether the UE supports inter-UE CLI reporting of per-downlink-subband measurement values.

In a tenth aspect, alone or in combination with one or more of the first through ninth aspects, the N CLI-RSSI measurement resources are an N most interfering resources of the one or more CLI-RSSI measurement resources.

In an eleventh aspect, alone or in combination with one or more of the first through tenth aspects, the N CLI-RSSI measurement resources are an N least interfering resources of the one or more CLI-RSSI measurement resources.

In a twelfth aspect, alone or in combination with one or more of the first through eleventh aspects, the N CLI-RSSI measurement resources include an N most interfering resources of the one or more CLI-RSSI measurement resources based at least in part on a preconfiguration of the UE.

In a thirteenth aspect, alone or in combination with one or more of the first through twelfth aspects, the N CLI-RSSI measurement resources include an N least interfering resources of the one or more CLI-RSSI measurement resources based at least in part on a preconfiguration of the UE.

In a fourteenth aspect, alone or in combination with one or more of the first through thirteenth aspects, the N CLI-RSSI measurement resources include an N most interfering resources of the one or more CLI-RSSI measurement resources based at least in part on a layer 1 CLI report configuration received from a network node.

In a fifteenth aspect, alone or in combination with one or more of the first through fourteenth aspects, the N CLI-RSSI measurement resources include an N least interfering resources of the one or more CLI-RSSI measurement resources based at least in part on a layer 1 CLI report configuration received from a network node.

In a sixteenth aspect, alone or in combination with one or more of the first through fifteenth aspects, the N CLI-RSSI measurement resources include an N most interfering resources of the one or more CLI-RSSI measurement resources according to a default rule and based at least in part on absence of a specific configuration from a layer 1 CLI report configuration.

In a seventeenth aspect, alone or in combination with one or more of the first through sixteenth aspects, the N CLI-RSSI measurement resources include an N least interfering resources of the one or more CLI-RSSI measurement resources according to a default rule and based at least in part on absence of a specific configuration from a layer 1 CLI report configuration.

In an eighteenth aspect, alone or in combination with one or more of the first through seventeenth aspects, process 700 includes transmitting UE capability information indicating that the UE supports only a downlink/uplink subband frequency configuration in SBFD symbols, where the one or more CLI-RSSI measurements include a CLI-RSSI measurement performed in a single downlink subband of the CLI-RSSI measurement resource.

In a nineteenth aspect, alone or in combination with one or more of the first through eighteenth aspects, process 700 includes transmitting UE capability information indicating that the UE supports a downlink/uplink/downlink subband frequency configuration in SBFD symbols.

In a twentieth aspect, alone or in combination with one or more of the first through nineteenth aspects, process 700 includes transmitting UE capability information indicating whether the UE supports CLI-RSSI measurements in CLI-RSSI measurement resources configured within single downlink subbands or whether the UE supports CLI-RSSI measurements in CLI-RSSI measurement resources configured across multiple downlink subbands.

In a twenty-first aspect, alone or in combination with one or more of the first through twentieth aspects, the N CLI-RSSI measurement resources are ordered within the CLI report based at least in part on a maximum CLI-RSSI of one downlink subband of the plurality of downlink subbands per each CLI-RSSI measurement resource of the one or more CLI-RSSI measurement resources measured by the UE.

In a twenty-second aspect, alone or in combination with one or more of the first through twenty-first aspects, the N CLI-RSSI measurement resources are ordered within the CLI report based at least in part on a minimum CLI-RSSI of one downlink subband of the plurality of downlink subbands per each CLI-RSSI measurement resource of the one or more CLI-RSSI measurement resources measured by the UE.

In a twenty-third aspect, alone or in combination with one or more of the first through twenty-second aspects, the CLI report comprises a plurality of CLI-RSSI measurement resource indicator fields and a plurality of per-downlink-subband measurement value fields, where each CLI-RSSI measurement resource indicator field of the plurality of CLI-RSSI measurement resource indicator fields maps to a respective per-downlink-subband measurement value field of the plurality of per-downlink-subband measurement value fields.

In a twenty-fourth aspect, alone or in combination with one or more of the first through twenty-third aspects, the CLI report comprises a one-bit indication that indicates a reporting order of an upper downlink subband and a lower downlink subband per-downlink-subband measurement values associated with a given CLI measurement resource.

In a twenty-fifth aspect, alone or in combination with one or more of the first through twenty-fourth aspects, the reporting order is based at least in part on a most interfering subband of a most interfering CLI-RSSI measurement resource of the one or more CLI-RSSI measurement resources.

In a twenty-sixth aspect, alone or in combination with one or more of the first through twenty-fifth aspects, the reporting order is based at least in part on a least interfering subband of a least interfering CLI-RSSI measurement resource of the one or more CLI-RSSI measurement resources.

In a twenty-seventh aspect, alone or in combination with one or more of the first through twenty-sixth aspects, a per-downlink-subband measurement value field of the plurality of per-downlink-subband measurement value fields indicates an absolute value, and other per-downlink-subband measurement value fields of the plurality of per-downlink-subband measurement value fields indicate differential values relative to the absolute value.

In a twenty-eighth aspect, alone or in combination with one or more of the first through twenty-seventh aspects, per-downlink-subband measurement values, associated with a given CLI measurement resource indicator field of the plurality of CLI measurement resource indicator fields, are ordered within the CLI report according to a predefined downlink subband order.

In a twenty-ninth aspect, alone or in combination with one or more of the first through twenty-eighth aspects, a first per-downlink-subband measurement value field of the plurality of per-downlink-subband measurement value fields indicates a first absolute value, a second per-downlink-subband measurement value field of the plurality of per-downlink-subband measurement value fields indicates a second absolute value, and other per-downlink-subband measurement value fields of the plurality of per-downlink-subband measurement value fields indicate differential values relative to either the first absolute value or the second absolute value.

In a thirtieth aspect, alone or in combination with one or more of the first through twenty-ninth aspects, a determination of a particular CLI-RSSI measurement resource, of the N CLI-RSSI measurement resources, reported as the first absolute value and the second absolute value is based at least in part on a downlink subband of the particular CLI-RSSI measurement resource being a most interfering subband of a most interfering CLI-RSSI measurement resource of the one or more CLI-RSSI measurement resources.

In a thirty-first aspect, alone or in combination with one or more of the first through thirtieth aspects, a determination of a particular CLI-RSSI measurement resource, of the N CLI-RSSI measurement resources, reported as the first absolute value and the second absolute value is based at least in part on a downlink subband of the particular CLI-RSSI measurement resource being a least interfering subband of a least interfering CLI-RSSI measurement resource of the one or more CLI-RSSI measurement resources.

In a thirty-second aspect, alone or in combination with one or more of the first through thirty-first aspects, the CLI report comprises a first one-bit indication that indicates a downlink subband, of a plurality of downlink subbands associated with a given CLI-RSSI measurement resource, that is associated with a first CLI-RSSI measurement resource indicator field of the plurality of CLI-RSSI measurement resource indicator fields, and a second one-bit indication that indicates another downlink subband, of the plurality of downlink subbands associated with the given CLI-RSSI measurement resource, that is associated with a second CLI-RSSI measurement resource indicator field of the plurality of CLI-RSSI measurement resource indicator fields.

In a thirty-third aspect, alone or in combination with one or more of the first through thirty-second aspects, a per-downlink-subband measurement value field of the plurality of per-downlink-subband measurement value fields indicates an absolute value, and other per-downlink-subband measurement value fields of the plurality of per-downlink-subband measurement value fields indicate differential values relative to the absolute value.

In a thirty-fourth aspect, alone or in combination with one or more of the first through thirty-third aspects, the CLI report comprises a plurality of per-downlink-subband measurement value fields, where a first per-downlink-subband measurement value field of the plurality of per-downlink-subband measurement value fields indicates a per-downlink-subband measurement value corresponding to a first downlink subband of the plurality of downlink subbands of the CLI measurement resource, and a second per-downlink-subband measurement value field of the plurality of per-downlink-subband measurement value fields indicates a per-downlink-subband measurement value corresponding to a second downlink subband of the plurality of downlink subbands of the CLI measurement resource.

In a thirty-fifth aspect, alone or in combination with one or more of the first through thirty-fourth aspects, the first downlink subband is an upper downlink subband of the plurality of downlink subbands of the CLI-RSSI measurement resource and the second downlink subband is a lower downlink subband of the plurality of downlink subbands of the CLI-RSSI measurement resource.

In a thirty-sixth aspect, alone or in combination with one or more of the first through thirty-fifth aspects, the first downlink subband is a lower downlink subband of the plurality of downlink subbands of the CLI-RSSI measurement resource and the second downlink subband is an upper downlink subband of the plurality of downlink subbands of the CLI-RSSI measurement resource.

In a thirty-seventh aspect, alone or in combination with one or more of the first through thirty-sixth aspects, a downlink subband order associated with reporting of the per-downlink-subband value corresponding to the first downlink subband and the per-downlink-subband value corresponding to the second downlink subband is preconfigured on the UE.

In a thirty-eighth aspect, alone or in combination with one or more of the first through thirty-seventh aspects, the CLI report indicates a single per-downlink-subband measurement value associated with the CLI-RSSI measurement resource.

In a thirty-ninth aspect, alone or in combination with one or more of the first through thirty-eighth aspects, the single per-downlink-subband measurement value corresponds to a maximum CLI-RSSI of a plurality of CLI-RSSIs associated with the plurality of downlink subbands of the CLI-RSSI measurement resource.

In a fortieth aspect, alone or in combination with one or more of the first through thirty-ninth aspects, the single per-downlink-subband measurement value corresponds to an average CLI-RSSI of a plurality of CLI-RSSIs associated with the plurality of downlink subbands of the CLI-RSSI measurement resource.

In a forty-first aspect, alone or in combination with one or more of the first through fortieth aspects, the single per-downlink-subband measurement value corresponds to a minimum CLI-RSSI of a plurality of CLI-RSSIs associated with the plurality of downlink subbands of the CLI-RSSI measurement resource.

In a forty-second aspect, alone or in combination with one or more of the first through forty-first aspects, the CLI report indicates a differential value that indicates a single per-downlink-subband measurement value associated with another CLI-RSSI measurement resource of the N CLI-RSSI measurement resources.

In a forty-third aspect, alone or in combination with one or more of the first through forty-second aspects, a quantity of CLI-RSSI measurement resources in the N CLI-RSSI measurement resources for which measurement values are reported is based at least in part on an configuration received from a network node.

In a forty-fourth aspect, alone or in combination with one or more of the first through forty-third aspects, a quantity of CLI-RSSI measurement resources in the N CLI-RSSI measurement resources for which measurement values are reported is based at least in part on a UE capability.

In a forty-fifth aspect, alone or in combination with one or more of the first through forty-fourth aspects, process 700 includes determining a CLI-RSSI measurement resource, of the one or more CLI-RSSI measurement resources, based at least in part on excluding an uplink subband and one or more guard bands, indicated by an SBFD frequency configuration indication, from a contiguous CLI-RSSI measurement resource indicated by a CLI-RSSI measurement resource configuration, such that the one or more CLI-RSSI measurement resources comprise one or more non-contiguous CLI-RSSI measurement resources.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 6A-6E. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may perform one or more CLI-RSSI measurements in one or more CLI-RSSI measurement resources in one or more SBFD symbols. The transmission component 804 may transmit a CLI report based at least in part on the one or more CLI-RSSI measurements, where the CLI report indicates one or more measurement values associated with N (N≥1) CLI-RSSI measurement resources of the one or more CLI-RSSI measurement resources, the one or more measurement values including at least one of a single wideband measurement value indicating an average CLI-RSSI associated with a plurality of downlink subbands of a CLI-RSSI measurement resource of the N CLI-RSSI measurement resources, or one or more per-downlink-subband measurement values indicating one or more CLI-RSSIs associated with one or more downlink subbands of the plurality of downlink subbands of the CLI-RSSI measurement resource of the N CLI-RSSI measurement resources.

The communication manager 806 may determine a CLI-RSSI measurement resource, of the one or more CLI-RSSI measurement resources, based at least in part on excluding an uplink subband and one or more guard bands, indicated by an SBFD frequency configuration indication, from a contiguous CLI-RSSI measurement resource indicated by a CLI-RSSI measurement resource configuration.

The transmission component 804 may transmit UE capability information indicating whether the UE supports inter-UE CLI reporting of single wideband measurement values or whether the UE supports inter-UE CLI reporting of per-downlink-subband measurement values.

The transmission component 804 may transmit UE capability information indicating that the UE supports only a downlink/uplink subband frequency configuration in SBFD symbols, where the one or more CLI-RSSI measurements include a CLI-RSSI measurement performed in a single downlink subband of the CLI-RSSI measurement resource.

The transmission component 804 may transmit UE capability information indicating that the UE supports a downlink/uplink/downlink subband frequency configuration in SBFD symbols.

The transmission component 804 may transmit UE capability information indicating whether the UE supports CLI-RSSI measurements in CLI-RSSI measurement resources configured within single downlink subbands or whether the UE supports CLI-RSSI measurements in CLI-RSSI measurement resources configured across multiple downlink subbands.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a user equipment (UE), comprising: performing one or more cross link interference (CLI) received signal strength indicator (RSSI) measurements in one or more CLI-RSSI measurement resources in one or more subband full duplex (SBFD) symbols; and transmitting a CLI report based at least in part on the one or more CLI-RSSI measurements, wherein the CLI report indicates one or more measurement values associated with a first number N (N≥1) of CLI-RSSI measurement resources of the one or more CLI-RSSI measurement resources, the one or more measurement values including at least one of: a single wideband measurement value indicating an average CLI-RSSI associated with a plurality of downlink subbands of a CLI-RSSI measurement resource of the first number (N) of CLI-RSSI measurement resources, or one or more per-downlink-subband measurement values indicating one or more CLI-RSSIs associated with one or more downlink subbands of the plurality of downlink subbands of the CLI-RSSI measurement resource of the first number (N) of CLI-RSSI measurement resources.
Aspect 2: The method of Aspect 1, wherein the one or more CLI-RSSI measurement resources comprise one or more non-contiguous CLI-RSSI measurement resources.
Aspect 3: The method of any of Aspects 1-2, wherein the one or more measurement values include the single wideband measurement value based at least in part on an indication received from a network node.
Aspect 4: The method of any of Aspects 1-3, wherein the one or more measurement values include the one or more per-downlink-subband measurement values based at least in part on an indication received from a network node.
Aspect 5: The method of any of Aspects 1-4, wherein the one or more measurement values include the single wideband measurement value based at least in part on a preconfiguration of the UE.
Aspect 6: The method of any of Aspects 1-5, wherein the one or more measurement values include the one or more per-downlink-subband measurement values based at least in part on a preconfiguration of the UE.
Aspect 7: The method of any of Aspects 1-6, wherein the one or more measurement values include the single wideband measurement value according to a default rule and based at least in part on absence of a specific configuration from a layer 1 CLI report configuration.
Aspect 8: The method of any of Aspects 1-7, wherein the one or more measurement values include the one or more per-downlink-subband measurement values according to a default rule and based at least in part on absence of a specific configuration from a layer 1 CLI report configuration.
Aspect 9: The method of any of Aspects 1-8, further comprising determining a CLI-RSSI measurement resource, of the one or more CLI-RSSI measurement resources, based at least in part on excluding an uplink subband and one or more guard bands, indicated by an SBFD frequency configuration indication, from a contiguous CLI-RSSI measurement resource indicated by a CLI-RSSI measurement resource configuration.
Aspect 10: The method of any of Aspects 1-9, further comprising transmitting UE capability information indicating whether the UE supports inter-UE CLI reporting of single wideband measurement values or whether the UE supports inter-UE CLI reporting of per-downlink-subband measurement values.
Aspect 11: The method of any of Aspects 1-10, wherein the first number (N) of CLI-RSSI measurement resources are the first number (N) most interfering resources of the one or more CLI-RSSI measurement resources.
Aspect 12: The method of any of Aspects 1-11, wherein the first number (N) of CLI-RSSI measurement resources are the first number (N) least interfering resources of the one or more CLI-RSSI measurement resources.
Aspect 13: The method of any of Aspects 1-12, wherein the first number (N) of CLI-RSSI measurement resources include the first number (N) most interfering resources of the one or more CLI-RSSI measurement resources based at least in part on a preconfiguration of the UE.
Aspect 14: The method of any of Aspects 1-13, wherein the first number (N) of CLI-RSSI measurement resources include the first number (N) least interfering resources of the one or more CLI-RSSI measurement resources based at least in part on a preconfiguration of the UE.
Aspect 15: The method of any of Aspects 1-14, wherein the first number (N) of CLI-RSSI measurement resources include the first number (N) most interfering resources of the one or more CLI-RSSI measurement resources based at least in part on a layer 1 CLI report configuration received from a network node.
Aspect 16: The method of any of Aspects 1-15, wherein the first number (N) of CLI-RSSI measurement resources include the first number (N) least interfering resources of the one or more CLI-RSSI measurement resources based at least in part on a layer 1 CLI report configuration received from a network node.
Aspect 17: The method of any of Aspects 1-16, wherein the first number (N) of CLI-RSSI measurement resources include the first number (N) most interfering resources of the one or more CLI-RSSI measurement resources according to a default rule and based at least in part on absence of a specific configuration from a layer 1 CLI report configuration.
Aspect 18: The method of any of Aspects 1-17, wherein the first number (N) of CLI-RSSI measurement resources include the first number (N) least interfering resources of the one or more CLI-RSSI measurement resources according to a default rule and based at least in part on absence of a specific configuration from a layer 1 CLI report configuration.
Aspect 19: The method of any of Aspects 1-18, further comprising transmitting UE capability information indicating that the UE supports only a downlink/uplink subband frequency configuration in SBFD symbols, wherein the one or more CLI-RSSI measurements include a CLI-RSSI measurement performed in a single downlink subband of the CLI-RSSI measurement resource.
Aspect 20: The method of any of Aspects 1-19, further comprising transmitting UE capability information indicating that the UE supports a downlink/uplink/downlink subband frequency configuration in SBFD symbols.
Aspect 21: The method of any of Aspects 1-20, further comprising transmitting UE capability information indicating whether the UE supports CLI-RSSI measurements in CLI-RSSI measurement resources configured within single downlink subbands or whether the UE supports CLI-RSSI measurements in CLI-RSSI measurement resources configured across multiple downlink subbands.
Aspect 22: The method of any of Aspects 1-21, wherein the first number (N) of CLI-RSSI measurement resources are ordered within the CLI report based at least in part on a maximum CLI-RSSI of one downlink subband of the plurality of downlink subbands per each CLI-RSSI measurement resource of the one or more CLI-RSSI measurement resources measured by the UE.
Aspect 23: The method of any of Aspects 1-22, wherein the first number (N) of CLI-RSSI measurement resources are ordered within the CLI report based at least in part on a minimum CLI-RSSI of one downlink subband of the plurality of downlink subbands per each CLI-RSSI measurement resource of the one or more CLI-RSSI measurement resources measured by the UE.
Aspect 24: The method of any of Aspects 1-23, wherein the CLI report comprises a plurality of CLI-RSSI measurement resource indicator fields and a plurality of per-downlink-subband measurement value fields, wherein each CLI-RSSI measurement resource indicator field of the plurality of CLI-RSSI measurement resource indicator fields maps to a respective per-downlink-subband measurement value field of the plurality of per-downlink-subband measurement value fields.
Aspect 25: The method of Aspect 24, wherein the CLI report comprises a one-bit indication that indicates a reporting order of an upper downlink subband and a lower downlink subband per-downlink-subband measurement values associated with a given CLI measurement resource.
Aspect 26: The method of Aspect 25, wherein the reporting order is based at least in part on a most interfering subband of a most interfering CLI-RSSI measurement resource of the one or more CLI-RSSI measurement resources.
Aspect 27: The method of Aspect 25, wherein the reporting order is based at least in part on a least interfering subband of a least interfering CLI-RSSI measurement resource of the one or more CLI-RSSI measurement resources.
Aspect 28: The method of Aspect 25, wherein a per-downlink-subband measurement value field of the plurality of per-downlink-subband measurement value fields indicates an absolute value, and other per-downlink-subband measurement value fields of the plurality of per-downlink-subband measurement value fields indicate differential values relative to the absolute value.
Aspect 29: The method of Aspect 24, wherein per-downlink-subband measurement values, associated with a given CLI measurement resource indicator field of the plurality of CLI measurement resource indicator fields, are ordered within the CLI report according to a predefined downlink subband order.
Aspect 30: The method of Aspect 29, wherein a first per-downlink-subband measurement value field of the plurality of per-downlink-subband measurement value fields indicates a first absolute value, a second per-downlink-subband measurement value field of the plurality of per-downlink-subband measurement value fields indicates a second absolute value, and other per-downlink-subband measurement value fields of the plurality of per-downlink-subband measurement value fields indicate differential values relative to either the first absolute value or the second absolute value.
Aspect 31: The method of Aspect 30, wherein a determination of a particular CLI-RSSI measurement resource, of the first number (N) of CLI-RSSI measurement resources, reported as the first absolute value and the second absolute value is based at least in part on a downlink subband of the particular CLI-RSSI measurement resource being a most interfering subband of a most interfering CLI-RSSI measurement resource of the one or more CLI-RSSI measurement resources.
Aspect 32: The method of Aspect 30, wherein a determination of a particular CLI-RSSI measurement resource, of the first number (N) of CLI-RSSI measurement resources, reported as the first absolute value and the second absolute value is based at least in part on a downlink subband of the particular CLI-RSSI measurement resource being a least interfering subband of a least interfering CLI-RSSI measurement resource of the one or more CLI-RSSI measurement resources.
Aspect 33: The method of Aspect 24, wherein the CLI report comprises a first one-bit indication that indicates a downlink subband, of a plurality of downlink subbands associated with a given CLI-RSSI measurement resource, that is associated with a first CLI-RSSI measurement resource indicator field of the plurality of CLI-RSSI measurement resource indicator fields, and a second one-bit indication that indicates another downlink subband, of the plurality of downlink subbands associated with the given CLI-RSSI measurement resource, that is associated with a second CLI-RSSI measurement resource indicator field of the plurality of CLI-RSSI measurement resource indicator fields.
Aspect 34: The method of Aspect 33, wherein a per-downlink-subband measurement value field of the plurality of per-downlink-subband measurement value fields indicates an absolute value, and other per-downlink-subband measurement value fields of the plurality of per-downlink-subband measurement value fields indicate differential values relative to the absolute value.
Aspect 35: The method of any of Aspects 1-34, wherein the CLI report comprises a plurality of per-downlink-subband measurement value fields, wherein a first per-downlink-subband measurement value field of the plurality of per-downlink-subband measurement value fields indicates a per-downlink-subband measurement value corresponding to a first downlink subband of the plurality of downlink subbands of the CLI measurement resource, and a second per-downlink-subband measurement value field of the plurality of per-downlink-subband measurement value fields indicates a per-downlink-subband measurement value corresponding to a second downlink subband of the plurality of downlink subbands of the CLI measurement resource.
Aspect 36: The method of Aspect 35, wherein the first downlink subband is an upper downlink subband of the plurality of downlink subbands of the CLI-RSSI measurement resource and the second downlink subband is a lower downlink subband of the plurality of downlink subbands of the CLI-RSSI measurement resource.
Aspect 37: The method of Aspect 35, wherein the first downlink subband is a lower downlink subband of the plurality of downlink subbands of the CLI-RSSI measurement resource and the second downlink subband is an upper downlink subband of the plurality of downlink subbands of the CLI-RSSI measurement resource.
Aspect 38: The method of Aspect 35, wherein a downlink subband order associated with reporting of the per-downlink-subband value corresponding to the first downlink subband and the per-downlink-subband value corresponding to the second downlink subband is preconfigured on the UE.
Aspect 39: The method of any of Aspects 1-38, wherein the CLI report indicates a single per-downlink-subband measurement value associated with the CLI-RSSI measurement resource.
Aspect 40: The method of Aspect 39, wherein the single per-downlink-subband measurement value corresponds to a maximum CLI-RSSI of a plurality of CLI-RSSIs associated with the plurality of downlink subbands of the CLI-RSSI measurement resource.
Aspect 41: The method of Aspect 39, wherein the single per-downlink-subband measurement value corresponds to an average CLI-RSSI of a plurality of CLI-RSSIs associated with the plurality of downlink subbands of the CLI-RSSI measurement resource.
Aspect 42: The method of Aspect 39, wherein the single per-downlink-subband measurement value corresponds to a minimum CLI-RSSI of a plurality of CLI-RSSIs associated with the plurality of downlink subbands of the CLI-RSSI measurement resource.
Aspect 43: The method of Aspect 39, wherein the CLI report indicates a differential value that indicates a single per-downlink-subband measurement value associated with another CLI-RSSI measurement resource of the N CLI-RSSI measurement resources.
Aspect 44: The method of any of Aspects 1-43, wherein a quantity of CLI-RSSI measurement resources in the first number (N) of CLI-RSSI measurement resources for which measurement values are reported is based at least in part on an configuration received from a network node.
Aspect 45: The method of any of Aspects 1-44, wherein a quantity of CLI-RSSI measurement resources in the first number (N) of CLI-RSSI measurement resources for which measurement values are reported is based at least in part on a UE capability.
Aspect 46: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-45.
Aspect 47: An apparatus for wireless communication at a device, the apparatus comprising one or more memories and one or more processors coupled to the one or more memories, the one or more processors configured to cause the device to perform the method of one or more of Aspects 1-45.
Aspect 48: An apparatus for wireless communication, the apparatus comprising at least one means for performing the method of one or more of Aspects 1-45.
Aspect 49: A non-transitory computer-readable medium storing code for wireless communication, the code comprising instructions executable by one or more processors to perform the method of one or more of Aspects 1-45.
Aspect 50: A non-transitory computer-readable medium storing a set of instructions for wireless communication, the set of instructions comprising one or more instructions that, when executed by one or more processors of a device, cause the device to perform the method of one or more of Aspects 1-45.
Aspect 51: A device for wireless communication, the device comprising a processing system that includes one or more processors and one or more memories coupled with the one or more processors, the processing system configured to cause the device to perform the method of one or more of Aspects 1-45.
Aspect 52: An apparatus for wireless communication at a device, the apparatus comprising one or more memories and one or more processors coupled to the one or more memories, the one or more processors individually or collectively configured to cause the device to perform the method of one or more of Aspects 1-45.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
perform one or more cross link interference (CLI) received signal strength indicator (RSSI) measurements in one or more CLI-RSSI measurement resources in one or more subband full duplex (SBFD) symbols; and
transmit a CLI report based at least in part on the one or more CLI-RSSI measurements, wherein the CLI report indicates one or more measurement values associated with a first number of CLI-RSSI measurement resources of the one or more CLI-RSSI measurement resources, the one or more measurement values including at least one of:
a single wideband measurement value indicating an average CLI-RSSI associated with a plurality of downlink subbands of a CLI-RSSI measurement resource of the first number of CLI-RSSI measurement resources, or
one or more per-downlink-subband measurement values indicating one or more CLI-RSSIs associated with one or more downlink subbands of the plurality of downlink subbands of the CLI-RSSI measurement resource of the first number of CLI-RSSI measurement resources.

2. The UE of claim 1, wherein the one or more processors are further configured to cause the UE to determine a CLI-RSSI measurement resource, of the one or more CLI-RSSI measurement resources, based at least in part on excluding an uplink subband and one or more guard bands, indicated by an SBFD frequency configuration indication, from a contiguous CLI-RSSI measurement resource indicated by a CLI-RSSI measurement resource configuration, such that the one or more CLI-RSSI measurement resources comprise one or more non-contiguous CLI-RSSI measurement resources.

3. The UE of claim 1, wherein the one or more measurement values include the single wideband measurement value based at least in part on an indication received from a network node.

4. The UE of claim 1, wherein the one or more measurement values include the one or more per-downlink-subband measurement values based at least in part on an indication received from a network node.

5. The UE of claim 1, wherein the one or more measurement values include the single wideband measurement value based at least in part on a preconfiguration of the UE.

6. The UE of claim 1, wherein the one or more measurement values include the one or more per-downlink-subband measurement values based at least in part on a preconfiguration of the UE.

7. The UE of claim 1, wherein the one or more processors are further configured to cause the UE to transmit UE capability information indicating whether the UE supports inter-UE CLI reporting of single wideband measurement values or whether the UE supports inter-UE CLI reporting of per-downlink-subband measurement values.

8. The UE of claim 1, wherein the first number of CLI-RSSI measurement resources are the first number most interfering resources of the one or more CLI-RSSI measurement resources.

9. The UE of claim 1, wherein the first number of CLI-RSSI measurement resources are the first number least interfering resources of the one or more CLI-RSSI measurement resources.

10. The UE of claim 1, wherein the first number of CLI-RSSI measurement resources include the first number most interfering resources of the one or more CLI-RSSI measurement resources according to a default rule and based at least in part on absence of a specific configuration from a layer 1 CLI report configuration.

11. The UE of claim 1, wherein the first number of CLI-RSSI measurement resources include the first number least interfering resources of the one or more RSSI measurement resources according to a default rule and based at least in part on absence of a specific configuration from a layer 1 CLI report configuration.

12. The UE of claim 1, wherein the one or more processors are further configured to cause the UE to transmit UE capability information indicating that the UE supports only a downlink/uplink subband frequency configuration in SBFD symbols, wherein the one or more CLI-RSSI measurements include a CLI-RSSI measurement performed in a single downlink subband of the CLI-RSSI measurement resource.

13. The UE of claim 1, wherein the one or more processors are further configured to cause the UE to transmit UE capability information indicating that the UE supports a downlink/uplink/downlink subband frequency configuration in SBFD symbols.

14. The UE of claim 1, wherein the one or more processors are further configured to cause the UE to transmit UE capability information indicating whether the UE supports CLI-RSSI measurements in CLI-RSSI measurement resources configured within single downlink subbands or whether the UE supports CLI-RSSI measurements in CLI-RSSI measurement resources configured across multiple downlink subbands.

15. The UE of claim 1, wherein the first number of CLI-RSSI measurement resources are ordered within the CLI report based at least in part on a maximum CLI-RSSI of one downlink subband of the plurality of downlink subbands per each CLI-RSSI measurement resource of the one or more CLI-RSSI measurement resources measured by the UE.

16. The UE of claim 1, wherein the first number of CLI-RSSI measurement resources are ordered within the CLI report based at least in part on a minimum CLI-RSSI of one downlink subband of the plurality of downlink subbands per each CLI-RSSI measurement resource of the one or more CLI-RSSI measurement resources measured by the UE.

17. The UE of claim 1, wherein the CLI report comprises a plurality of CLI-RSSI measurement resource indicator fields and a plurality of per-downlink-subband measurement value fields, wherein each CLI-RSSI measurement resource indicator field of the plurality of CLI-RSSI measurement resource indicator fields maps to a respective per-downlink-subband measurement value field of the plurality of per-downlink-subband measurement value fields.

18. The UE of claim 1, wherein the CLI report comprises a plurality of per-downlink-subband measurement value fields, wherein a first per-downlink-subband measurement value field of the plurality of per-downlink-subband measurement value fields indicates a per-downlink-subband measurement value corresponding to a first downlink subband of the plurality of downlink subbands of the CLI measurement resource, and a second per-downlink-subband measurement value field of the plurality of per-downlink-subband measurement value fields indicates a per-downlink-subband measurement value corresponding to a second downlink subband of the plurality of downlink subbands of the CLI measurement resource.

19. The UE of claim 1, wherein the CLI report indicates a single per-downlink-subband measurement value associated with the CLI-RSSI measurement resource.

20. A method of wireless communication performed by a user equipment (UE), comprising:
performing one or more cross link interference (CLI) received signal strength indicator (RSSI) measurements in one or more CLI-RSSI measurement resources in one or more subband full duplex (SBFD) symbols; and
transmitting a CLI report based at least in part on the one or more CLI-RSSI measurements, wherein the CLI report indicates one or more measurement values associated with a first number of CLI-RSSI measurement resources of the one or more CLI-RSSI measurement resources, the one or more measurement values including at least one of:
a single wideband measurement value indicating an average CLI-RSSI associated with a plurality of downlink subbands of a CLI-RSSI measurement resource of the first number of CLI-RSSI measurement resources, or
one or more per-downlink-subband measurement values indicating one or more CLI-RSSIs associated with one or more downlink subbands of the plurality of downlink subbands of the CLI-RSSI measurement resource of the first number of CLI-RSSI measurement resources.
